(19) United States
(12) Patent Application Publication
(10) Pub. No.: US 2024/0000650 A1
(43) Pub. Date: Jan. 4, 2024

(54) APPARATUS AND A PROCESS FOR ADAPTING A DEVICE TO A LAND SURFACE

(71) Applicant: Reece Scott, Galveston, TX (US)

(72) Inventor: Reece Scott, Galveston, TX (US)

(21) Appl. No.: 18/346,228

(22) Filed: Jul. 1, 2023

Related U.S. Application Data
(60) Provisional application No. 63/367,608, filed on Jul. 2, 2022.

(51) Int. Cl. A61H 3/02

(52) U.S. Cl. CPC A61H 3/0288; A61H 2201/0153

(57) ABSTRACT

An apparatus comprising an adapting component and a releasably-connecting component. A process comprising releasably connecting an apparatus and a device. The apparatus comprises an adapting component and a releasably-connecting component.

This application claims the benefit of U.S. Provisional Patent Application No. 63/367,608 filed Jul. 2, 2022 the entirety of which is incorporated herein by reference.

### BACKGROUND OF THE INVENTION

The invention relates to an apparatus and a process for adapting a device to a land surface.

A person using a device, for example, a walker, a wheeled walker, a rollator walker, a gait trainer, a stroller, and combinations thereof, may encounter difficulty when adapting the device to a land surface, for example, dirt, mud, grass, sand, snow, and combinations thereof. The device may become hindered, or even stopped, when adapting to the land surface. Also, for example, when a person is using the device to move along a man-made surface, for example, a floor, a pavement, a sidewalk, and combinations thereof, the person may encounter difficulty when adapting the device to the land surface, transitioning the device from the man-made surface to the land surface, transitioning the device from the land surface to the man-made surface, and combinations thereof. The device may become hindered, or even stopped, when adapting, transitioning, and combinations thereof. The person using the device, and any occupants of the device, for example, when using a stroller, may have to stay on the man-made surface.

Thus, there is a need for an apparatus and a process for adapting a device to a land surface.

### SUMMARY OF THE INVENTION

An apparatus comprising an adapting component and a releasably-connecting component.

A process comprising releasably connecting an apparatus and a device. The apparatus comprises an adapting component and a releasably-connecting component.

### BRIEF DESCRIPTION OF THE DRAWINGS

For a detailed understanding of embodiments of the invention, reference is made to the following description of example embodiments, taken in conjunction with the accompanying drawings, in which like elements have been given like numbers, wherein:

FIG. 1 is an isometric view of a first example embodiment of an apparatus comprising an adapting component and a releasably-connecting component;

FIG. 2 is an isometric view of the first example embodiment of the apparatus comprising an adapting component and a releasably-connecting component;

FIG. 3 is a cross-sectional view of the first example embodiment of the apparatus taken along line 3-3 of FIG. 1;

FIG. 4 is an isometric view of a second example embodiment of an apparatus comprising an adapting component and a releasably-connecting component;

FIG. 5 is an isometric view of the second example embodiment of the apparatus comprising an adapting component and a releasably-connecting component;

FIG. 6 is a cross-sectional view of the second example embodiment of the apparatus taken along line 6-6 of FIG. 4;

FIG. 7 is an isometric view of a third example embodiment of an apparatus comprising an adapting component and a releasably-connecting component;

FIG. 8 is an isometric view of the third example embodiment of the apparatus comprising an adapting component and a releasably-connecting component;

FIG. 9 is a cross-sectional view of the third example embodiment of the apparatus taken along line 9-9 of FIG. 7;

FIG. 10 is an isometric view of a fourth example embodiment of an apparatus comprising an adapting component and a releasably-connecting component;

FIG. 11 is a cross-sectional view of the fourth example embodiment of the apparatus taken along line 11-11 of FIG. 10;

FIG. 12 is an isometric view of example embodiments of the apparatus shown in FIGS. 1-6 and FIGS. 10-11 being utilized on a wheeled walker;

FIG. 13 is an isometric view of example embodiments of the apparatus shown in FIGS. being utilized on a walker;

FIG. 14 is an isometric view of example embodiments of the apparatus shown in FIGS. 1-9 being utilized on a rollator walker;

FIG. 15 is an isometric view of example embodiments of the apparatus shown in FIGS. 7-9 being utilized on a gait trainer;

FIG. 16 is an isometric view of example embodiments of the apparatus shown in FIGS. 1-3 that has been modified and being utilized on a first stroller;

FIG. 17 is an isometric view of example embodiments of the apparatus shown in FIGS. 1-9 that has been modified and being utilized on a second stroller;

FIG. 18 is an exploded view of a fifth example embodiment of an apparatus comprising an adapting component and a releasably-connecting component before releasably connecting;

FIG. 19 is an isometric view of an upper surface of the adapting component of the fifth example embodiment shown in FIG. 18;

FIG. 20 is a cross-sectional view of the adapting component of the fifth example embodiment of the apparatus taken along line 20-20 of FIG. 19;

FIG. 21 is a cross-sectional view of the releasably-connecting component of the fifth example embodiment of the apparatus taken along line 21-21 of FIG. 18;

FIG. 22 is an isometric view of a lower surface of the releasably-connecting component of the fifth example embodiment shown in FIG. 18;

FIG. 23 is an exploded view of a sixth example embodiment of an apparatus comprising an adapting component and a releasably-connecting component before releasably connecting;

FIG. 24 is an isometric view of an upper surface of the adapting component of the sixth example embodiment shown in FIG. 23;

FIG. 25 is a cross-sectional view of the adapting component of the sixth example embodiment of the apparatus taken along line 25-25 of FIG. 24;

FIG. 26 is an isometric view of a lower surface of the releasably-connecting component of the sixth example embodiment shown in FIG. 23; and

FIG. 27 is an isometric view of example embodiments of the apparatus shown in FIGS. 18-26 after releasably connecting and being utilized on a wheeled walker.

### DETAILED DESCRIPTION OF THE INVENTION

An apparatus of the invention may comprise an adapting component. An adapting component of the invention may comprise any adapting component that suitably provides for an adapting of an apparatus of the invention to a land surface as described herein. The adapting component may comprise any suitable shape and any suitable size that may be used in accordance with the invention. An example of a suitable adapting component comprises a discal component. A discal component of the invention may comprise any suitable shape and any suitable size that may be used in accordance with the invention. Examples of a suitable shape of the discal component include, but are not limited to, circular, spherical, spheroid, oval, ovoid, ovaloid, elliptical, ellipsoid, and combinations thereof. Examples of a suitable discal component include, but are not limited to, a circular disc, a spherical disc, a spheroid disc, an oval disc, an ovoid disc, an ovaloid disc, an elliptical disc, an ellipsoid disc, and combinations thereof. When an adapting component comprises a discal component, the discal component may be generally concave providing for a concave discal component. Examples of a suitable concave discal component include, but are not limited to, a concave circular disc, a concave spherical disc, a concave spheroid disc, a concave oval disc, a concave ovoid disc, a concave ovaloid disc, a concave elliptical disc, a concave ellipsoid disc, and combinations thereof. An example of an adapting component comprises a circular disc, a spherical disc, or a spheroid disc. Another example of an adapting component comprises a concave circular disc, a concave spherical disc, or a concave spheroid disc. Another example of an adapting component comprises a concave circular disc.

An adapting component of the invention may comprise an adapting component top surface and an adapting component bottom surface that may provide for an adapting component thickness. The adapting component may comprise any adapting component thickness that may be used in accordance with the invention. The adapting component thickness may comprise a uniform thickness, a varying thickness, and combinations thereof. The adapting component top surface may be concave that may provide for a concave adapting component top surface. The adapting component bottom surface may be convex that may provide for a convex adapting component bottom surface.

An adapting component of the invention may comprise an edge component. An edge component of the invention may comprise any suitable shape and any suitable size that may be used in accordance with the invention. The edge component may comprise a generally rounded shape. Examples of a suitable shape of the edge component include, but are not limited to, circular, spherical, spheroid, oval, ovoid, ovaloid, elliptical, ellipsoid, cylindrical, cylindroid, and combinations thereof. Examples of a suitable shape of the edge component also include, but are not limited to, a generally partial shape comprising any part of a shape. Examples of a suitable partial shape of the edge component include, but are not limited to, a generally half shape, for example, a generally semi shape or a generally hemi shape, for example, semicircular, hemispherical, hemispheroid, semioval, semiovoid, semiovaloid, semielliptical, semiellipsoid, semicylindrical, semicylindroid, and combinations thereof.

An edge component size may be equal to the adapting component thickness, less than the adapting component thickness, more than the adapting component thickness, and combinations thereof. An example edge component size may be equal to the adapting component thickness. An edge component size that is greater than the adapting component thickness may provide for a generally bulbous-shaped edge component or a generally lip-shaped edge component.

A suitable shape of an edge component of the invention may totally encompass a perimeter of the adapting component, partially encompass a perimeter of the adapting component, and combinations thereof. An example of the edge component includes, but is not limited to, a semicircular edge component, a hemispherical edge component, or a hemispheroid edge component totally encompassing a perimeter of the adapting component. Another example of the edge component includes, but is not limited to, a semicircular edge component, a hemispherical edge component, or a hemispheroid edge component partially encompassing a perimeter of the adapting component.

An apparatus of the invention may provide for an adapting of a device to a land surface as described herein. An apparatus of the invention may provide for an ability of a person using a device to adapt the device to a land surface without interfering with the person's stride or gait. An adapting component of the invention may comprise a modified section providing for a space for a person's stride or gait. A modified section may be provided by the shape of the adapting component, by removing a section of the adapting component, and combinations thereof.

An apparatus of the invention may comprise a releasably-connecting component. A releasably-connecting component of the invention may comprise any releasably-connecting component that suitably provides for a releasably connecting of an apparatus and a device as described herein. The releasably-connecting component may comprise any suitable shape and any suitable size that may be used in accordance with the invention. Examples of a suitable shape of the releasably-connecting component include, but are not limited to, circular, spherical, spheroid, oval, ovoid, ovaloid, elliptical, ellipsoid, square, cubical, rectangular, cuboid, cylindrical, cylindroid, conical, triangular, pyramidical, prismatic, and combinations thereof. Examples of a suitable shape of the releasably-connecting component also include, but are not limited to, a generally partial shape comprising any part of a shape. Examples of a suitable partial shape of the releasably-connecting component include, but are not limited to, a generally half shape, for example, a generally semi shape or a generally hemi shape, for example, semicircular, hemispherical, hemispheroid, semioval, semiovoid, semiovaloid, semielliptical, semiellipsoid, semisquare, semicubical, semirectangular, semicuboid, semicylindrical, semicylindroid, and combinations thereof. A partial-conical shape may comprise a conical shape where a section may be missing, for example, a point or a tip of the conical shape may be missing. A partial-triangular shape may comprise a triangular shape where a section may be missing, for example, a point or a tip of the triangular shape may be missing. A partial-pyramidical shape may comprise a pyramidical shape where a section may be missing, for example, a point or a tip of the pyramidical shape may be missing. A partial-prismatic shape may comprise a prismatic shape where a section may be missing, for example, a pointed ridge of the prismatic shape may be missing.

A releasably-connecting component of the invention may comprise a releasably-connecting component inner surface and a releasably-connecting component outer surface that provide for a releasably-connecting component thickness. The releasably-connecting component may comprise any releasably-connecting component thickness that may be used in accordance with the invention. The releasably-connecting component thickness may comprise a uniform thickness, a varying thickness, and combinations thereof. The releasably-connecting component may comprise a releasably-connecting component wall. A releasably-connecting component wall of the invention may comprise any releasably-connecting component wall thickness that may be used in accordance with the invention. The releasably-connecting component wall thickness may comprise a uniform thickness, a varying thickness, and combinations thereof. The releasably-connecting component wall may comprise a continuous component, separate components, and combinations thereof. The releasably-connecting component wall may comprise a wall section. Examples of a suitable wall section include, but are not limited to, a front wall section, a back wall section, a first side wall section, a second side wall section, and combinations thereof. The front wall section may be opposite the back wall section. The first side wall section may be opposite the second side wall section. The front wall section and the back wall section may be substantially parallel and may comprise substantially the same length. The first side wall section and the second side wall section may be substantially parallel and may comprise substantially the same length.

A releasably-connecting component of the invention may comprise an upper perimeter. An upper perimeter of the invention may comprise a level, more than one level, and combinations thereof. The upper perimeter may comprise an upper perimeter groove providing for a passageway for a leg, a frame, a brake component, and combinations thereof. An upper perimeter groove of the invention may comprise any suitable shape and any suitable size that may be used in accordance with the invention. Examples of a suitable shape of the upper perimeter groove include, but are not limited to, the partial shapes described herein for a releasably-connecting component. The upper perimeter groove may be angled from an inner surface of a releasably-connecting component to an outer surface of the releasably-connecting component.

A releasably-connecting component of the invention may comprise a releasably-connecting component first section and a releasably-connecting component second section. The releasably-connecting component first section and the releasably-connecting component second section may be separated providing for a releasably-connecting component gap section.

A releasably-connecting component may comprise a receiving space. A receiving space of the invention may comprise any receiving space that suitably provides for a receiving of a wheel, a leg, a frame, and combinations thereof as described herein. A receiving space of the invention may comprise any suitable shape and any suitable size that may be used in accordance with the invention. Examples of a suitable shape of the receiving space include, but are not limited to, circular, spherical, spheroid, oval, ovoid, ovaloid, elliptical, ellipsoid, square, cubical, rectangular, cuboid, cylindrical, cylindroid, conical, triangular, pyramidical, prismatic, and combinations thereof. Examples of a suitable shape of the receiving space also include, but are not limited to, a generally partial shape comprising any part of a shape. Examples of a suitable partial shape of the receiving space include, but are not limited to, a generally half shape, for example, a generally semi shape or a generally hemi shape, for example, semicircular, hemispherical, hemispheroid, semioval, semiovoid, semiovaloid, semielliptical, semiellipsoid, semisquare, semicubical, semirectangular, semicuboid, semicylindrical, semicylindroid, semiconical, semitriangular, semipyramidical, semiprismatic, and combinations thereof. A partial-conical shape may comprise a conical shape where a section may be missing, for example, a point or a tip of the conical shape may be missing. A partial-triangular shape may comprise a triangular shape where a section may be missing, for example, a point or a tip of the triangular shape may be missing. A partial-pyramidical shape may comprise a pyramidical shape where a section may be missing, for example, a point or a tip of the pyramidical shape may be missing. A partial-prismatic shape may comprise a prismatic shape where a section may be missing, for example, a pointed ridge of the prismatic shape may be missing.

A receiving space of the invention may comprise a shape and a size that may be similar in shape and size as the wheel, the leg, the frame, and combinations thereof that the receiving space receives. The receiving space may comprise a shape and a size that may provide for a form fitting or a form fit of the wheel, the leg, the frame, and combinations thereof that the receiving space receives. An inner surface of the releasably-connecting component may define the receiving space.

When a device comprises a wheel, a receiving space of the invention may comprise a shape that includes, but is not limited to, circular, spherical, spheroid, oval, ovoid, ovaloid, elliptical, ellipsoid, square, cubical, rectangular, cuboid, semicircular, hemispherical, hemispheroid, semioval, semiovoid, semiovaloid, semielliptical, semiellipsoid, semisquare, semicubical, semirectangular, semicuboid, and combinations thereof that provides for a shaped receiving space that receives the wheel. In a similar manner, the additional shapes of the receiving space described herein may provide for additional shaped receiving spaces that receive the wheel.

When a device comprises a leg, a receiving space of the invention may comprise a shape that includes, but is not limited to, square, cubical, cylindrical, cylindroid, semisquare, semicubical, semicylindrical, semicylindroid, and combinations thereof that provides for a shaped receiving space that receives the leg. In a similar manner, the additional shapes of the receiving space described herein may provide for additional shaped receiving spaces that receive the leg. An end of a leg may comprise a cap component, for example, a rubber cap, a cut-open tennis ball, a glider ski, a glider coaster, and combinations thereof. The receiving space may comprise a shape that includes, but is not limited to, square, cubical, cylindrical, cylindroid, semisquare, semicubical, semicylindrical, semicylindroid, and combinations thereof that provides for a shaped receiving space that receives the leg and the cap component. In a similar manner, the additional shapes of the receiving space described herein may provide for additional shaped receiving spaces that receive the leg and the cap component.

When a device comprises a straight frame, a receiving space of the invention may comprise a shape that includes, but is not limited to, oval, ovoid, ovaloid, elliptical, ellipsoid, square, cubical, rectangular, cuboid, triangular, semioval, semiovoid, semiovaloid, semielliptical, semiellipsoid, semisquare, semicubical, semirectangular, semicuboid, semitriangular, and combinations thereof that provides for a shaped receiving space that receives the straight frame. In a similar manner, the additional shapes of the receiving space described herein may provide for additional shaped receiving spaces that receive the straight frame.

When a device comprises a curved frame, a receiving space of the invention may comprise a shape that includes, but is not limited to, oval, ovoid, ovaloid, elliptical, ellipsoid, square, cubical, rectangular, cuboid, triangular, semioval, semiovoid, semiovaloid, semielliptical, semiellipsoid, semisquare, semicubical, semirectangular, semicuboid, semitriangular, and combinations thereof that provides for a shaped receiving space that receives the curved frame. In a similar manner, the additional shapes of the receiving space described herein may provide for additional shaped receiving spaces that receive the curved frame.

A receiving space may comprise a combination of shapes. For example, a receiving space of the invention may comprise a first receiving space section, a second receiving space section, a third receiving space section, and combinations thereof comprising shapes of receiving space as described herein. The first receiving space section, the second receiving space section, the third receiving space section, and combinations thereof may be generally adjacent, generally contiguous, and combinations thereof.

When a device comprises a wheel that is connected to a leg, a receiving space of the invention may comprise a combination of shapes that includes, but is not limited to, a first receiving space section comprising a shape that receives the wheel as described herein and a second receiving space section comprising a shape that receives the leg as described herein. When a device comprises a wheel that is connected to a straight frame, a receiving space of the invention may comprise a combination of shapes that includes, but is not limited to, a first receiving space section comprising a shape that receives the wheel as described herein and a second receiving space section comprising a shape that receives the straight frame as described herein. When a device comprises a wheel that is connected to a curved frame, a receiving space of the invention may comprise a combination of shapes that includes, but is not limited to, a first receiving space section comprising a shape that receives the wheel as described herein and a second receiving space section comprising a shape that receives the curved frame as described herein.

When a device comprises a wheel that is connected to a leg, the leg may be generally similar to a straight frame. When a device comprises a wheel connected to a leg, a receiving space of the invention may comprise a first receiving space section comprising a shape for receiving the wheel as described herein and a second receiving space section comprising a shape for receiving a straight frame as described herein that includes, but is not limited to, oval, ovoid, ovaloid, elliptical, ellipsoid, square, cubical, rectangular, cuboid, triangular, semioval, semiovoid, semiovaloid, semielliptical, semiellipsoid, semisquare, semicubical, semirectangular, semicuboid, semitriangular, and combinations thereof that provides for the second receiving space section for receiving the leg.

When a device comprises a wheel and a straight frame where the straight frame is connected to one side of the wheel, a receiving space of the invention may comprise a first receiving space section comprising a shape for receiving the wheel as described herein and a second receiving space section comprising a shape for receiving the straight frame as described herein. When a device comprises a wheel and a straight frame where the straight frame is connected to both sides of the wheel, for example, a U-shape frame, a receiving space of the invention may comprise a first receiving space section comprising a shape for receiving the wheel as described herein, a second receiving space section comprising a shape for receiving a first section of the straight frame as described herein located on one side of the wheel, and a third receiving space section comprising a shape for receiving a second section of the straight frame as described herein located on the other side of the wheel.

When a device comprises a wheel that is connected to a curved frame, a receiving space of the invention may comprise a first receiving space section comprising a shape for receiving the wheel as described herein and a second receiving space section comprising a shape for receiving the curved frame as described herein. When a device comprises a wheel and a curved frame where the curved frame is connected to both sides of the wheel, for example, a U-shape frame, a receiving space of the invention that may comprise a first receiving space section comprising a shape for receiving the wheel as described herein, a second receiving space section comprising a shape for receiving a first section of the curved frame as described herein located on one side of the wheel, and a third receiving space section comprising a shape for receiving a second section of the curved frame as described herein located on the other side of the wheel.

An apparatus of the invention may comprise a releasably-securing component. A releasably-securing component of the invention may comprise any releasably-securing component that suitably provides for a releasably securing of an apparatus and a device as described herein. A releasably-securing of an apparatus and a device as described herein may provide for a preventing of the device from being separated from the apparatus during use. A releasably-securing component of the invention may releasably secure an apparatus as described herein to a wheel, a leg, a frame, and combinations thereof. The releasably-securing component may be located at, near, above, below, and combinations thereof, a wheel, a leg, a frame, and combinations thereof. The releasably-securing component may be located at or near a spoke of a wheel, at or near a spoke of a wheel and a leg, at or near a spoke of a wheel and a frame, and combinations thereof. The releasably-securing component may be located between a first spoke of a wheel and a second spoke of the wheel, between a spoke of a wheel and a leg, between a spoke of a wheel and a frame, and combinations thereof. When a device comprises a solid wheel, a hole may be provided through the solid wheel by any means known in the art, for example, drilling, to provide for a wheel passageway that may receive the releasably-securing component.

Examples of a suitable releasably-securing component of the invention include, but are not limited to, a fastener, a latch, a clamp, a wedge, a strap, a cable, a wire, a rope, and combinations thereof. Examples of a suitable fastener include any fastener that may be used in accordance with the invention and include, but are not limited to, a hook-and-loop fastener, a snap fastener, a screw knob fastener, a nut-bolt fastener, a U-bolt fastener, a push button fastener, a male-female screw fastener, a snap clip fastener, a carabiner clip fastener, a backpack connector, and combinations thereof. Examples of a suitable latch include any latch that may be used in accordance with the invention and include, but are not limited to, a toggle latch, a draw latch, a slide latch, a casement window latch, and combinations thereof. Examples of a suitable clamp include any clamp that may be used in accordance with the invention and include, but are not limited to, a toggle clamp, a C-clamp, a rod clamp, and combinations thereof. An example releasably-securing component may comprise a double-sided hook-and-loop fastener and a ring where a section of the double-sided hook-and-loop fastener may be passed through the ring and then reversed back to fasten.

A first releasably-securing component of the invention, for example, a fastener, a latch, a clamp, a wedge, and combinations thereof may be connected at or near a first end of a second releasably-connecting component of the invention, for example, a strap, a cable, a wire, a rope, and combinations thereof. The first releasably-securing component may be connected at or near a first end of the second releasably-securing component and at or near a second, opposite end of the second releasably-securing component. The first releasably-securing component may be connected at or near a first end of the second releasably-securing component and a second, opposite end of the second releasably-securing component may be connected to the apparatus. When referring to a releasably-securing component, examples of connected include, but are not limited to, fixedly connected, releasably connected, and combinations thereof. A releasably-securing component may be formed as a part of an apparatus of the invention during a preparing of the apparatus as described herein.

A releasably-securing component of the invention may be used in a manner including releasably securing from a first releasably-securing location of the apparatus to a second releasably-securing location of the apparatus. The adapting component, the releasably-connecting component, and combinations thereof may comprise the first releasably-securing location, the second releasably-securing location, and combinations thereof. Examples of the first releasably-securing location of the apparatus include, but are not limited to, an inner location nearer to the user of the device, an outer location farther from the user of the device, a front location, a center location, a back location, an inner front location, an inner center location, an inner back location, an outer front location, an outer center location, an outer back location, and combinations thereof. Examples of the second releasably-securing location of an apparatus include, but are not limited to, an inner location nearer to the user of the device, an outer location farther from the user of the device, a front location, a center location, a back location, an inner front location, an inner center location, an inner back location, an outer front location, an outer center location, an outer back location, and combinations thereof.

Examples of releasably securing from the first releasably-securing location of the apparatus to the second releasably-securing location of the apparatus include, but are not limited to, releasably securing from an inner location nearer to the user of the device to an outer location farther from the user of the device, releasably securing from an outer location farther from the user of the device to an inner location nearer to the user of the device, releasably securing from a front location to a back location, releasably securing from a back location to a front location, releasably securing from an inner front location to an inner back location, releasably securing from an inner back location to an inner front location, releasably securing from an outer front location to an outer back location, releasably securing from an outer back location to an outer front location, releasably securing from an inner front location to an outer back location, releasably securing from an outer back location to an inner front location, releasably securing from an outer front location to an inner back location, releasably securing from an inner back location to an outer front location, and combinations thereof. A center location, an inner center location, an outer center location, and combinations thereof may be used in addition to, or in lieu of, the inner locations, the outer locations, the front locations, the back locations, and combinations thereof described herein for releasably securing from the first releasably-securing location of the apparatus to the second releasably-securing location of the apparatus.

A releasably-securing component of the invention, for example, a fastener, may comprise a male component, a female component, and combinations thereof. The male component may be connected at or near a first end of the releasably-securing component, for example, a strap, a cable, a wire, a rope, and combinations thereof, a second, opposite end of the releasably-securing component may be connected to the first releasably-securing location of the apparatus, and the female component may be connected to the second releasably-securing location of the apparatus. Similarly, the female component may be connected at or near the first end of a releasably-securing component, for example, a strap, a cable, a wire, a rope, and combinations thereof, the second, opposite end of the releasably-securing component may be connected to the first releasably-securing location of an apparatus, and the male component may be connected to the second releasably-securing location of the apparatus.

A first male component may be connected at or near the first end of the releasably-securing component, for example, a strap, a cable, a wire, a rope, and combinations thereof, a second male component may be connected to the second, opposite end of the releasably-securing component, a first female component may be connected to the first releasably-securing location of the apparatus, and a second female component may be connected to the second releasably-securing location of the apparatus. Similarly, the first female component may be connected at or near the first end of the releasably-securing component, for example, a strap, a cable, a wire, a rope, and combinations thereof, the second female component may be connected to the second, opposite end of the releasably-securing component, the first male component may be connected to the first releasably-securing location of the apparatus, and the second male component may be connected to the second releasably-securing location of the apparatus. Similarly, the first male component may be connected at or near the first end of the releasably-securing component, for example, a strap, a cable, a wire, a rope, and combinations thereof, the first female component may be connected to the second, opposite end of the releasably-securing component, the second female component may be connected to the first releasably-securing location of an apparatus, and the second male component may be connected to the second releasably-securing location of the apparatus.

The male component may be connected at or near the first end of the first releasably-securing component, for example, a strap, a cable, a wire, a rope, and combinations thereof, the second, opposite end of the first releasably-securing component may be connected to the first releasably-securing location of the apparatus, the female component may be connected at or near the first end of the second releasably-securing component, for example, a strap, a cable, a wire, a rope, and combinations thereof, and the second, opposite end of the second releasably-securing component may be connected to the second releasably-securing location of the apparatus.

A releasably-securing component of the invention may be used in a manner including, releasably securing from an inner location to an outer location back to the inner location and back to the outer location for a first wrapping around a wheel, a leg, a frame, and combinations thereof. The releasably-securing component may be used in a manner including, releasably securing from the outer location to the inner location back to the outer location and back to the inner location for a second wrapping around a wheel, a leg, a frame, and combinations thereof. The releasably-securing component may be used in a manner including, releasably securing from the inner location to the outer location and back to the inner location for a third wrapping around a wheel, a leg, a frame, and combinations thereof. The releasably-securing component may be used in a manner including, releasably securing from a first inner location to the outer location and back to a second inner location for a fourth wrapping around a wheel, a leg, a frame, and combinations thereof. The releasably-securing component may be used in a manner including, releasably securing from the outer location to the inner location and back to the outer location providing for a fifth wrapping around a wheel, a leg, a frame, and combinations thereof. The releasably-securing component may be used in a manner including releasably securing from a first outer location to the inner location and back to a second outer location providing for a sixth wrapping around a wheel, a leg, a frame, and combinations thereof.

When the first wrapping, the second wrapping, the third wrapping, the fourth wrapping, the fifth wrapping, the sixth wrapping, and combinations thereof are utilized, a resulting crisscross or X configuration may be provided with a wheel, a leg, a frame, and combinations thereof generally at the center of the resulting crisscross or X configuration. The first wrapping may be extended by repeating the inner-outer-inner-outer manner to provide for additional wrapping around a wheel, a leg, a frame, and combinations thereof. The second wrapping may be extended by repeating the outer-inner-outer-inner manner to provide for additional wrapping around a wheel, a leg, a frame, and combinations thereof. The third wrapping, the fourth wrapping, and combinations thereof may be extended by repeating the inner-outer-inner manner to provide for additional wrapping around a wheel, a leg, a frame, and combinations thereof. The fifth wrapping, the sixth wrapping, and combinations thereof may be extended by repeating the outer-inner-outer manner to provide for additional wrapping around a wheel, a leg, a frame, and combinations thereof.

Examples of a suitable screw knob fastener include any screw knob fastener that may be used in accordance with the invention. A screw knob fastener of the invention may comprise a screw, a knob connected at a first end of the screw, and a generally flat second end of the screw opposite the first end of the screw. The screw knob fastener may comprise a screw, a knob connected at a first end of the screw, and a contacting component connected at a second end of the screw opposite the first end of the screw. A contacting component of the invention may comprise any suitable shape and any suitable size that may be used in accordance with the invention. Examples of a suitable shape of the contacting component include, but are not limited to, the shapes described herein for a releasably-connecting component of the invention. A contacting component may comprise a contacting component diameter that may be generally larger than the diameter of the screw, equal to the diameter of the screw, smaller than the diameter of the screw, and combinations thereof. An example of a contacting component comprises a contacting component diameter that may be generally larger than the diameter of the screw.

Turning the knob of the screw knob fastener connected at a first end of the screw in a first direction may provide for a releasably contacting of the second end of the screw or the contacting component connected at the second end of the screw with a wheel, a leg, a frame, a spoke of a wheel, the adapting component, the releasably-connecting component, and combinations thereof. Turning the knob connected at a first end of the screw in a second direction opposite of the first direction may provide for a releasably separating of the second end of the screw or the contacting component connected at the second of the screw from the wheel, the leg, the frame, the spoke of a wheel, the adapting component, the releasably-connecting component, and combinations thereof. Turning the knob of the screw knob fastener may provide for a traversing of the second end of the screw or the contacting component connected at the second end of the screw.

A knob of a screw knob fastener of the invention may be located at a first side of a first wall of the releasably-connecting component. A second end of the screw or the contacting component connected at the second of the screw may be located at a second side of the first wall of the releasably-connecting component opposite the first side of the first wall with the screw passing through a wall passageway in the first wall. A wall passageway of the releasably connecting component may comprise a groove providing for a grooved wall passageway. A contacting component diameter may be generally larger than the diameter of the screw and the diameter of the wall passageway. A generally larger contacting component diameter may provide for a preventing of the contacting component connected at the second end of the screw from entering the wall passageway of the releasably-connecting component, for example, when releasably separating the contacting component connected at the second of the screw from the wheel, the leg, the frame, the spoke of a wheel, the adapting component, the releasably-connecting component, and combinations thereof. A preventing of the contacting component connected at the second end of the screw from entering the wall passageway of the releasably-connecting component may provide for a preventing of a separating of the screw knob fastener from the wall of the releasably-connecting component.

Turning the knob of the screw knob fastener located at the first side of the first wall of the releasably-connecting component in a first direction may provide for a releasably contacting of the second end of the screw or the contacting component connected at the second end of the screw with a first side of a second wall of the releasably-connecting component opposite the first wall. Turning the knob of the screw knob fastener located at the first side of the first wall of the releasably-connecting component in a second direction opposite of the first direction may provide for a releasably separating of the second end of the screw or the contacting component connected at the second of the screw from the first side of the second wall of the releasably-connecting component opposite the first wall. The location of the releasably contacting at the first side of the second wall may comprise a wall passageway as described herein to receive the second end of the screw. The location of the releasably contacting at the first side of the second wall may comprise a wall indentation in the first side of the second wall to receive the second end of the screw or the contacting component connected at the second of the screw. The wall indentation in the first side of the second wall of the releasably-connecting component may comprise a groove providing for a grooved wall indentation.

A latch, for example, a toggle latch, a draw latch, a slide latch, a casement window latch, and combinations thereof may comprise an arm component, an arm-receiving component, and combinations thereof. The arm component, the arm-receiving component, and combinations thereof may be fixedly connected, releasably connected, and combinations thereof to an apparatus of the invention. The arm component of the latch may be located on or near the first releasably-securing location of the apparatus. The arm component of the latch may provide for a lifting over and back of the arm component, a turning of the arm component, an extending of the arm component, and combinations thereof to contact the second releasably-securing location of the apparatus opposite the first releasably-securing location. The arm-receiving component of a latch may be located on or near the second releasably-securing location opposite the first releasably-securing location to provide for a receiving of the arm component.

A lifting over and back, a turning, an extending, and combinations thereof, of the arm component of the latch may be conducted at, near, above, below, and combinations thereof, a wheel, a leg, a frame, and combinations thereof. A lifting over and back, a turning, an extending, and combinations thereof, of the arm component of the latch may be conducted between a first spoke of a wheel and a second spoke of the wheel, between a spoke of a wheel and a leg, between a spoke of a wheel and a frame, and combinations thereof. A lifting over and back, a turning, an extending, and combinations thereof, of the arm component of the latch may be conducted through a wheel passageway of a solid wheel as described herein. Turning of the arm component of the latch includes a clockwise turning, a counterclockwise turning, and combinations thereof.

A releasably-securing component of the invention may comprise a clamp, for example, a toggle clamp, comprising an arm component comprising an arm component end. The arm component end may comprise a covering, for example, a rubber cap. The arm component of the toggle clamp may be located on or near the first releasably-securing location of the apparatus providing for a lifting over and back of the arm component to connect the arm component end onto or near the second releasably-securing location of the apparatus opposite the first releasably-securing location. A lifting over and back of the arm component of the toggle clamp may be conducted at, near, above, below, and combinations thereof, a wheel, a leg, a frame, and combinations thereof. A lifting over and back of the arm component of the toggle clamp may be conducted between a first spoke of a wheel and a second spoke of the wheel, between a spoke of a wheel and a leg, between a spoke of a wheel and a frame, and combinations thereof. A lifting over and back of the arm component of the toggle clamp may be conducted through a wheel passageway of a solid wheel as described herein.

A releasably-securing component of the invention may comprise a clamp, for example, a C-clamp, a rod clamp, and combinations thereof. The clamp may comprise a generally C-shape frame, a generally O-shape frame, and combinations thereof. The clamp may comprise a first section, comprising a handle-connector component, and an opposing second section. The first section of the clamp and the opposing second section of the clamp may comprise a continuous section, separate sections, and combinations thereof. The first section of the clamp may be located at or near the first releasably-securing location of the apparatus providing for a connecting of the opposing second section of the clamp at or near the second releasably-securing location of the apparatus opposite the first releasably-securing location followed by engaging the handle-connector component. A wheel, a spoke of a wheel, a leg, a frame, the adapting component, the releasably-connecting component, and combinations thereof may be located between the first section of the clamp and the opposing second section of the clamp.

A releasably-securing component of the invention may comprise a wedge. The wedge may be located at any location that suitably provides for the wedge to be wedged between two objects. The wedge may be located, for example, between the releasably-connecting component and a wheel, between the releasably-connecting component and a spoke of a wheel, between the releasably-connecting component and a leg, between the releasably-connecting component and a frame, and combinations thereof. A location of the wedge between the releasably-connecting component and a wheel, a spoke of a wheel, a leg, a frame, and combinations thereof may be located in a receiving space of the releasably-connecting component. The wedge may be located between a wheel and a leg, a wheel and a frame, a spoke of a wheel and a leg, a spoke of a wheel and a frame, and combinations thereof. The wedge may be located at, near, and combinations thereof a swivel, for example, when a device comprises a swivel wheel, two swivel wheels, and combinations thereof as described herein. The wedge located at, near, and combinations thereof a swivel may provide for a hindering, a stopping, and combinations thereof of a swiveling of a swivel wheel, two swivel wheels, and combinations thereof.

A device may comprise a wheel that rotates forward and backward around a horizontal axis and is stationary around a vertical axis. A device may comprise a swivel wheel that rotates forward and backward around a horizontal axis and swivels around a vertical axis, for example, a caster wheel. A device may comprise two swivel wheels, that rotate forward and backward around a horizontal axis and swivel around a vertical axis, for example, a double-wheel caster, also referred to as a dual-wheel caster or a twin-wheel caster. A device may comprise a wheel, a swivel wheel, two swivel wheels, and combinations thereof. A wheel, a swivel wheel, two swivel wheels, and combinations thereof may comprise a brake component. A brake component may comprise any suitable brake component that may be used in accordance with the invention. Examples of a brake component include, but are not limited to, a hand brake component, a foot brake component, and combinations thereof. A releasably-securing component of the invention may provide for a hindering of a wheel, a swivel wheel, two swivel wheels, and combinations thereof. The releasably-securing component may provide for a hindering of a rotating of a wheel, a swivel wheel, two swivel wheels, and combinations thereof. The releasably-securing component may provide for a hindering of a swiveling of a swivel wheel, two swivel wheels, and combinations thereof.

An apparatus of the invention may comprise a sleeve component. The sleeve component may provide for a preventing of a device from being separated from the apparatus during use. The sleeve component may be located at, near, above, below, and combinations thereof, a wheel, a leg, a frame, and combinations thereof. The sleeve component may be located at or near a spoke of a wheel, at or near a spoke of a wheel and a leg, at or near a spoke of a wheel and a frame, and combinations thereof. The sleeve component may be passed between a first spoke of a wheel and a second spoke of the wheel, between a spoke of a wheel and a leg, between a spoke of a wheel and a frame, and combinations thereof. The sleeve component may comprise any sleeve component that suitably provides for an ability to fasten the sleeve component around a wheel, a spoke of a wheel, a leg, a frame, and combinations thereof. The sleeve component may comprise a releasably-securing component of the invention. The sleeve component may comprise the releasably-securing component comprising a double-sided hook-and-loop fastener and a ring where a section of the double-sided hook-and-loop fastener may be passed through the ring and then reversed back to fasten. The sleeve component may comprise, for example, a releasable cable tie, a drawstring, a zipper, and combinations thereof.

An apparatus of the invention may comprise an electronic component. Examples of a suitable electronic component of the invention include any electronic component that may be used in accordance with the invention. Examples of a suitable electronic component include, but are not limited to, a photo component, a video component, an internet component, and combinations thereof. An electronic component of the invention may comprise a wireless connection to the internet to provide for a monitoring of the apparatus from a location remote from the apparatus. When the apparatus and the device are releasably connected, the electronic component comprising a wireless connection to the internet may provide for a monitoring of the apparatus, the device, and combinations thereof from a location remote from the apparatus, the device, and combinations thereof.

An apparatus of the invention may be utilized for a device comprising a wheel, a leg, a frame, and combinations thereof as described herein. A wheel, a leg, a frame, and combinations thereof may be located at or near a position of a device, at or near more than one position of a device, and combinations thereof. An apparatus of the invention may be located at or near a position of a device, at or near more than one position of a device, and combinations thereof. Examples of a position of a device include, but are not limited to, front, back, left, right, left front, center front, right front, left back, center back, right back, left center, right center, and combinations thereof. An apparatus of the invention may comprise a single unit that may be located at or near a position of a device. An apparatus of the invention may comprise more than one single unit where each single unit is located at or near a position of a device. An apparatus of the invention may comprise more than one single unit integrated to provide for an integrated unit that may be located at or near more than one position of a device. An apparatus of the invention comprising an integrated unit that may be located at or near more than one position of a device may comprise an adapting component comprising a shape as described herein that may be generally elongated to provide for a generally elongated shape. A generally elongated shape may also be referred to as a generally oblong shape. Examples of a generally elongated shape include, but are not limited to, an oval-shape configuration, a U-shape configuration, a horseshoe-shape configuration, a V-shape configuration, an O-shape configuration, and combinations thereof.

A wheel, a leg, a frame, and combinations thereof may be located, at or near a left front of the device and at or near a right front of the device. An apparatus of the invention may comprise one integrated unit comprising an oval-shape configuration that may be located at or near the front of the device and releaseably connects to the left front and to the right front. A wheel, a leg, a frame, and combinations thereof may be located, at or near a left front of the device and at or near a left back of the device. An apparatus of the invention may comprise one integrated unit comprising an oval-shape configuration that may be located at or near the left of the device and releaseably connects to the left front and to the left back. A wheel, a leg, a frame, and combinations thereof may be located at or near a right front of the device and at or near a right back of the device. An apparatus of the invention may comprise one integrated unit comprising a generally oval-shape configuration that may be located at or near the right of the device and releaseably connects to the right front and to the right back.

A wheel, a leg, a frame, and combinations thereof may be located, at or near a left front of the device, at or near a right front of the device, at or near a left back of the device, and at or near a right back of the device. An apparatus of the invention may comprise one integrated unit comprising a U-shape configuration, a horseshoe-shape configuration, and combinations thereof that may be located at or near the left of the device, at or near the front of the device, and at or near the right of the device and releaseably connects to the left front, to the right front, to the left back, and to the right back. A wheel, a leg, a frame, and combinations thereof may be located, at or near a left back of the device, at or near a center front of the device, and at or near a right back of the device. An apparatus of the invention may comprise one integrated unit comprising a U-shape configuration, a horseshoe-shape configuration, a V-shape configuration, and combinations thereof that may be located at or near the left of the device, at or near the center of the device, and at or near the right of the device and releaseably connects to the left back, to the center front, and to the right back. A wheel, a leg, a frame, and combinations thereof may be located, at or near two or more positions around the perimeter of the device, for example, when the device comprises a gait trainer. An apparatus of the invention may comprise one integrated unit comprising a U-shape configuration, an O-shape configuration, and combinations thereof that may be located at or near the two or more positions around the perimeter of the device and releasably connects to the two or more positions.

An apparatus of the invention may comprise any suitable material that may be used in accordance with the invention. Examples of a suitable material of the invention include, but are not limited to, plastic, thermoplastic, metal, wood, biobased material, and combinations thereof. Examples of a suitable material of the invention include, but are not limited to, a new material, a recycled material, and combinations thereof. An apparatus of the invention may be prepared using any suitable means known in the art, for example, three-dimensional (3D) printing, molding, blow molding, injection molding, extrusion molding, rotational molding, compression molding, thermoforming, metalworking, carving, shaping, and combinations thereof.

An apparatus of the invention may comprise one integrated unit. An example of an apparatus of the invention comprises one integrated unit prepared using a means known in the art, for example, three-dimensional (3D) printing, molding, blow molding, injection molding, extrusion molding, rotational molding, compression molding, thermoforming, and combinations thereof. An apparatus of the invention may comprise more than one section that may be connected by any suitable means known in the art, for example, adhesion, welding, and combinations thereof. An apparatus of the invention may comprise separate sections that may be connected by any suitable means known in the art, for example, adhesion, welding, and combinations thereof.

An apparatus of the invention may be pre-installed on a device or included with a device for later installment. In other embodiments, an apparatus of the invention and a device may comprise one integrated unit. In lieu of releasably-connecting an apparatus and a device as described herein, an apparatus of the invention may provide for a fixedly-connecting of the apparatus and the device by any suitable means known in the art, for example, adhesion, welding, crimping, and combinations thereof.

A process of the invention may comprise releasably connecting an apparatus of the invention and a device. The process may comprise releasably connecting an apparatus and a device where the apparatus comprises an adapting component and a releasably-connecting component. A device may comprise a wheel, a leg, a frame, and combinations thereof and the process may comprise releasably connecting the wheel, the leg, the frame, and combinations thereof. The process may comprise releasably disconnecting an apparatus and a device. The process may comprise releasably securing an apparatus and a device, releaseably unsecuring an apparatus and a device, and combinations thereof. The process may comprise adapting a device to a land surface.

A process of the invention may comprise lifting a device, tilting a device, and combinations thereof. The process may comprise lifting a device, tilting a device, and combinations thereof and releasably connecting an apparatus of the invention and the device. The process may comprise lifting a device, tilting a device, and combinations thereof and releasably connecting a releasably-connecting component of an apparatus of the invention and the device. The process may comprise lifting a device, tilting a device, and combinations thereof and releasably connecting a releasably-connecting component of the apparatus and a wheel, a leg, a frame, and combinations thereof of the device. The process may comprise lifting a device, tilting a device, and combinations thereof and receiving a wheel, a leg, a frame, and combinations thereof of the device in a receiving space of the releasably-connecting component of the apparatus. The process may comprise lifting a device, tilting a device, and combinations thereof and releasably disconnecting the apparatus and the device. The process may comprise lifting a device, tilting a device, and combinations thereof and releasably disconnecting the releasably-connecting component of the apparatus and the device. The process may comprise lifting a device, tilting a device, and combinations thereof and releasably disconnecting a releasably-connecting component of the apparatus and a wheel, a leg, a frame, and combinations thereof of the device. The process may comprise lifting a device, tilting a device, and combinations thereof and releasing a wheel, a leg, a frame, and combinations thereof of the device from a receiving space of the releasably-connecting component of the apparatus. Examples of a suitable tilting include any tilting that may be used in accordance with the invention. Examples of a suitable tilting include, but are not limited to, front to back, back to front, left to right, right to left, and combinations thereof.

A process of the invention may comprise releasably securing an apparatus and a device, releasably unsecuring an apparatus and a device, and combinations thereof. The process may comprise releasably securing an apparatus and a device after releasably connecting. The process may comprise releasably unsecuring an apparatus and a device before releasably disconnecting. The process may comprise releasably connecting an apparatus and a device, releasably securing the apparatus and the device, releasably unsecuring the apparatus and the device, and releasably disconnecting the apparatus and the device. The process may comprise engaging a brake component as described herein before releasably connecting, after releasably connecting, and combinations thereof. An example process may comprise engaging a brake component as described herein before releasably connecting. The process may comprise engaging a hand brake component, engaging a foot brake component, and combinations thereof.

A releasably-connecting component may comprise a first section and a second section that may be separated providing for a releasably-connecting component gap section as described herein. The releasably-connecting component gap section may comprise any dimensions that suitably provide for a process of the invention. A process of the invention may comprise contacting a releasably-connecting component gap section and a wheel of a device, rotating the apparatus, and aligning the wheel with the first section and the second section of the releasably-connecting component. The process may comprise wheeling a device from a land surface, a man-made surface, and combinations thereof to an edge component of an adapting component, wheeling the device from an edge component to a releasably-connecting component gap section, contacting the releasably-connecting component gap section and a wheel of the device, rotating the apparatus, and aligning the wheel with a first section and a second section of the releasably-connecting component. The process may comprise rotating an apparatus, wheeling a device from a releasably-connecting component gap section to an edge component of an adapting component, wheeling the device from the edge component to a land surface, a man-made surface, and combinations thereof. Wheeling, contacting, rotating, aligning, and combinations thereof may provide for the ability to releasably connect, releasably disconnect, and combinations thereof an apparatus and a device without lifting the device, tilting the device, and combinations thereof as described herein. The process may comprise releasably securing, releasably unsecuring, and combinations thereof of the apparatus and the device as described herein. The process may comprise engaging a brake component as described herein before rotating the apparatus and aligning the wheel.

After releasably connecting an apparatus of the invention and a device as described herein, a process of the invention may comprise adapting the device to a land surface, transitioning the device from a man-made surface to a land surface, transitioning the device from a land surface to a man-made surface, and combinations thereof. After adapting the device to a land surface, transitioning the device from a man-made surface to a land surface, transitioning the device from a land surface to a man-made surface, and combinations thereof using an apparatus of the invention, the process may comprise releasably disconnecting the apparatus and the device so that, for example, the device may be used on a man-made surface. The apparatus and the device may remain releasably connected so that the apparatus and the device may be used on a man-made surface. The process may comprise releasably securing, releasably unsecuring, and combinations thereof the apparatus and the device as described herein. The process may comprise engaging a brake component as described herein before releasably connecting the apparatus and the device.

Examples of a suitable land surface include any land surface that may be used in accordance with the invention. Examples of a land surface include, but are not limited to, dirt, mud, grass, sand, snow, and combinations thereof. Examples of a suitable man-made surface include any man-made surface that may be used in accordance with the invention. Examples of a man-made surface include, but not are limited to, a floor, a pavement, a sidewalk, and combinations thereof.

An apparatus of the invention may provide for an adapting of a device to a land surface as described herein. An apparatus of the invention may provide for an adapting of a device to a land surface in a manner providing for a generally three-hundred-and-sixty-degree range of movement.

A device may comprise a wheel, a leg, a frame, and combinations thereof. Examples of a suitable wheel, a suitable leg, a suitable frame, and combinations thereof include any wheel, any leg, any frame, and any combinations thereof that may be used in accordance with the invention. Examples of a suitable device include any device that may be used in accordance with the invention. Examples of a device include, but are not limited to, a walker, a wheeled walker, a rollator walker, a gait trainer, a stroller, and combinations thereof. Examples of a device as described herein include, but are not limited to, devices that may be utilized by a person of any age including, but not limited to, adult devices, children's devices, and combinations thereof.

A device may comprise a wheel, a swivel wheel, for example, a caster wheel, two swivel wheels, for example, a double-wheel caster, also referred to as a dual-wheel caster or a twin-wheel caster, and combinations thereof as described herein. A device may comprise a wheel comprising a spoke, a solid wheel that does not comprise a spoke, and combinations thereof. A device may comprise more than one wheel. A device may comprise a multi-wheel configuration where a position of the device comprising a single wheel comprises two or more wheels. A device may comprise a wheel that may be connected to a leg, a frame, and combinations thereof.

A wheel may be connected to a device, a wheel, a leg, a frame, and combinations thereof. Examples of a suitable wheel include any wheel that may be used in accordance with the invention.

Examples of a suitable leg include any leg that may be used in accordance with the invention. Examples of a leg include, but are not limited to, a post, a pole, a bar, and combinations thereof. A leg may be connected to a device, a wheel, a leg, a frame, and combinations thereof.

Examples of a suitable frame include any frame that may be used in accordance with the invention. Examples of a frame include, but are not limited to, a straight frame, a curved frame, and combinations thereof. A frame may be located on a side of a wheel, on both sides of a wheel, for example, a generally U-shape frame, and combinations thereof. A frame may be stationary around a vertical axis, swiveling around a vertical axis, and combinations thereof. A frame may be connected to a device, a wheel, a leg, a frame, and combinations thereof. A frame may comprise a first frame section, a second frame section, and combinations thereof as described herein.

Examples of a suitable walker include any walker that may be used in accordance with the invention. Examples of a walker include those that are generally commercially available. An example walker comprises a four-leg walker, also generally referred to as a standard walker, comprising four legs and no wheels. Each leg may comprise a terminal end comprising a cap component as described herein.

Examples of a suitable wheeled walker include any wheeled walker that may be used in accordance with the invention. Examples of a wheeled walker include those that are generally commercially available. Examples of a wheeled walker include, but are not limited to, a two-wheel walker, a four-wheel walker, and combinations thereof. An example two-wheel walker comprises four legs and two wheels where each wheel is connected at or near the terminal end of each front leg and stationary around a vertical axis and the two back legs each have a terminal end that may comprise a cap component. An example four-wheel walker comprises four legs and four wheels where two wheels are connected at or near the terminal end of each front leg and stationary around a vertical axis and the two back legs each have a terminal end that may comprise a cap component.

Examples of a suitable rollator walker include any rollator walker that may be used in accordance with the invention. Examples of a rollator walker include those that are generally commercially available. An example rollator walker may comprise a wheel that rotates forward and backward around a horizontal axis and is stationary around a vertical axis, a swiveling wheel that rotates forward and backward around a horizontal axis and swivels around a vertical axis, for example, a caster wheel, two swiveling wheels that rotate forward and backward around a horizontal axis and swivel around a vertical axis, for example, a double-wheel caster, and combinations thereof. An example rollator walker may comprise four legs and four wheels where a swiveling wheel, for example, a caster wheel, is connected at or near the terminal end of each front leg and a wheel that is stationary around a vertical axis is connected at or near the terminal end of each back leg. An example rollator walker may comprise four legs and six wheels where two swiveling wheels, for example, a double-wheel caster, are connected at or near the terminal end of each front leg and a wheel that is stationary around a vertical axis is connected at or near the terminal end of each back leg. An example rollator walker may comprise four legs and two swiveling wheels where a swiveling wheel, for example, a caster wheel, is connected at or near the terminal end of each front leg and the two back legs each have a terminal end that may comprise a cap component. An example rollator walker may comprise four legs and four wheels where two swiveling wheels, for example, a double-wheel caster, are connected at or near the terminal end of each front leg and the two back legs each have a terminal end that may comprise a cap component.

An example rollator walker may comprise three legs and three wheels where a swiveling wheel, for example, a caster wheel, is connected at or near the terminal end of the center front leg and a wheel that is stationary around a vertical axis is connected at or near the terminal end of each back leg. An example rollator walker may comprise, from an overhead view of a user using the rollator walker, three legs and four wheels where two swiveling wheels, for example, a double-wheel caster, are connected at or near the terminal end of the center front leg and a wheel that is stationary around a vertical axis is connected at or near the terminal end of each back leg. An example rollator walker may comprise three legs and one wheel where a swiveling wheel, for example, a caster wheel, is connected at or near the terminal end of the center front leg and the two back legs each have a terminal end that may comprise a cap component. An example rollator walker may comprise three legs and two wheels where two swiveling wheels, for example, a double-wheel caster, are connected at or near the terminal end of the center front leg and the two back legs each have a terminal end that may comprise a cap component. An example rollator walker may comprise a handle, a seat, a brake component, for example, a hand brake component, and combinations thereof.

Examples of a suitable gait trainer include any gait trainer that may be used in accordance with the invention. Examples of a gait trainer include those that are generally commercially available. An example gait trainer is generally used to assist persons learning to walk or improving gait as well as assisting persons with special needs, for example, cerebral palsy. An example gait trainer may comprise a stationary wheel that rotates forward and backward around a horizontal axis and is stationary around a vertical axis, a swiveling wheel that rotates forward and backward around a horizontal axis and swivels around a vertical axis, for example, a caster wheel, two swiveling wheels that rotate forward and backward around a horizontal axis and swivel around a vertical axis, for example, a double-wheel caster, and combinations thereof. An example gait trainer may comprise a wheel and leg configuration similar to the wheel and leg configurations described herein for a rollator walker comprising wheels and four legs. An example gait trainer may comprise a strap, a support, a positioner, a brake component, for example, a foot brake component, and combinations thereof.

Examples of a suitable stroller include any stroller that may be used in accordance with the invention. Examples of a stroller include those that are generally commercially available. An example stroller may comprise a wheel that rotates forward and backward around a horizontal axis and is stationary around a vertical axis, two wheels that rotate forward and backward around a horizontal axis and are stationary around a vertical axis, for example, a double-wheel, a swiveling wheel that rotates forward and backward around a horizontal axis and swivels around a vertical axis, for example, a caster wheel, two swiveling wheels that rotate forward and backward around a horizontal axis and swivel around a vertical axis, for example, a double-wheel caster, and combinations thereof. An example stroller may comprise a handle, a seat, and combinations thereof. A three-wheel stroller may comprise three wheels. A three-wheel stroller may comprise, in lieu of a single wheel at each single-wheel location, more than a single wheel, for example, two wheels, for example, a double-wheel or a double-wheel caster, at each single-wheel location providing for a six-wheel stroller. A three-wheel stroller may comprise, in lieu of a single wheel at the center front single-wheel location, more than a single wheel, for example, two wheels, for example, a double-wheel or a double-wheel caster, at the center front single-wheel location providing for a four-wheel stroller. A four-wheel stroller may comprise four wheels. A four-wheel stroller may comprise, in lieu of a single wheel at each single-wheel location, more than a single wheel, for example, two wheels, for example, for example, a double-wheel or a double-wheel caster, at each single-wheel location providing for an eight-wheel stroller. An example stroller may comprise a handle, a seat, and combinations thereof. Examples of a suitable stroller include, but are not limited to, a baby stroller, an animal stroller, a stroller wagon, and combinations thereof.

For example, when a person is using a device, for example, a walker, a wheeled walker, a rollator walker, a gait trainer, or a stroller, to move along a man-made surface, for example, a floor of a building or along a pavement or a sidewalk, the person may encounter difficulty when adapting the device to a land surface, transitioning the device from the man-made surface to the land surface, transitioning the device from the land surface to the man-made surface, and combinations thereof. The device may become hindered, or even stopped. The person may not be able to go outside of the building or onto the land surface adjacent to the pavement or the sidewalk, and may have to stay on the floor, on the pavement, or on the sidewalk. The person may have to stay inside or near the building. When an apparatus of the invention is utilized, the device may be adapted to the land surface so that the person may go onto the land surface.

Also, for example, when a child is using a device, for example, a walker, a wheeled walker, a rollator walker, or a gait trainer, to move along a man-made surface, for example, a floor of a building or along a pavement or a sidewalk, the child may encounter difficulty adapting the device to a land surface, transitioning the device from the man-made surface to the land surface, transitioning the device from the land surface to the man-made surface, and combinations thereof. The device may become hindered, or even stopped. For example, during school, the child may move the device along a school floor or along a pavement or a sidewalk adjacent to the school. The child may encounter difficulty when it is time to transition to a land surface, for example, by going onto an outside playground comprising the land surface. The child may have to stay inside or near the school building. When an apparatus of the invention is utilized, the device may be adapted to the land surface so that the child may go onto the outside playground.

Also, for example, when a person is using a device, for example, a stroller, to move along a man-made surface, for example, a floor of a building or along a pavement or a sidewalk, the person may encounter difficulty when adapting the device to a land surface, transitioning the device from the man-made surface to the land surface, transitioning the device from the land surface to the man-made surface, and combinations thereof. The stroller may become hindered, or even stopped. For example, a person may move the stroller along a floor of a building or along a pavement or a sidewalk. The person may encounter difficulty when transitioning to a land surface, for example, by going outside of the building or onto the land surface adjacent to the pavement or the sidewalk. The person, and any occupants of the stroller, may have to stay on the floor, on the pavement, or on the sidewalk. The person may have to stay inside or near the building. When an apparatus of the invention is utilized, the stroller may be adapted to the land surface so that the person, and any occupants of the stroller, may go onto the land surface.

An apparatus of the invention may be used to adapt a device including, for example, a cane, a crutch, a wheelchair, a medical stretcher, a knee walker, an animal walker, a skateboard, a scooter, a bicycle, a tricycle, a food grill, and combinations thereof that may comprise a wheel, a leg, a frame, and combinations thereof to a land surface, for example, dirt, mud, grass, sand, snow, and combinations thereof.

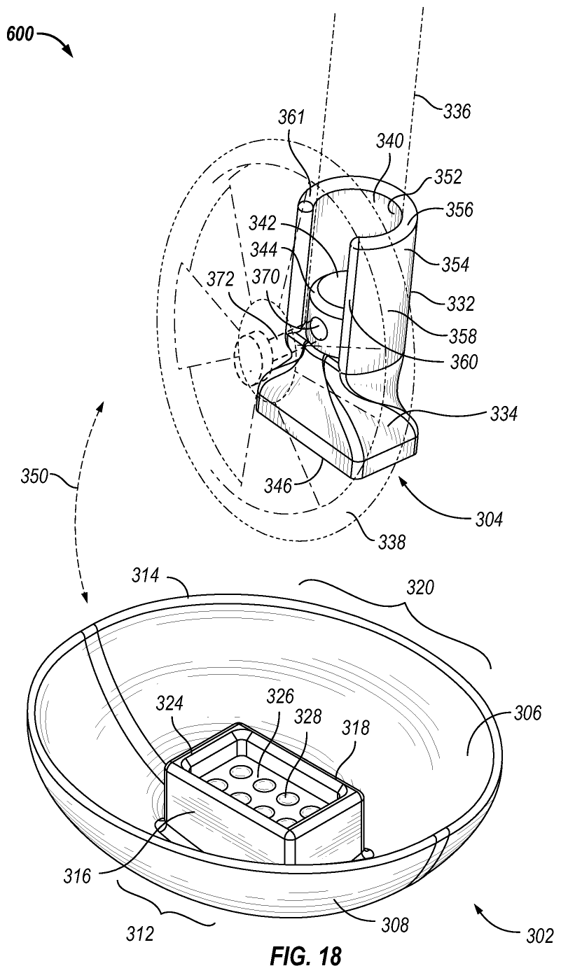

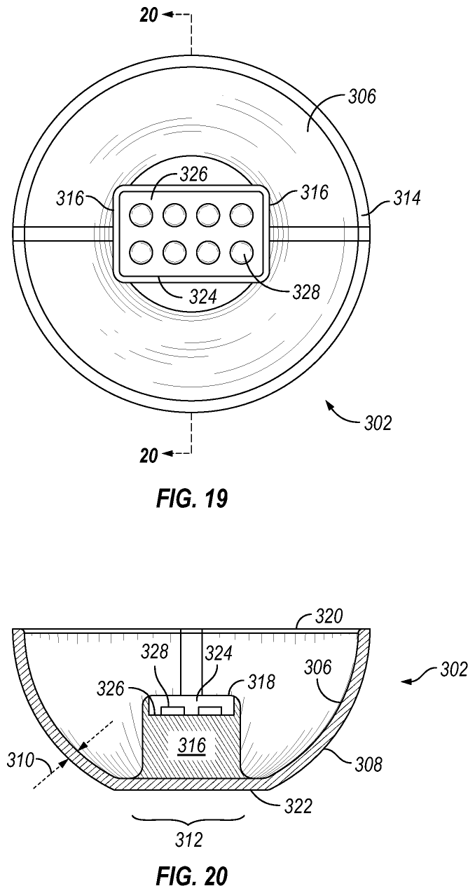

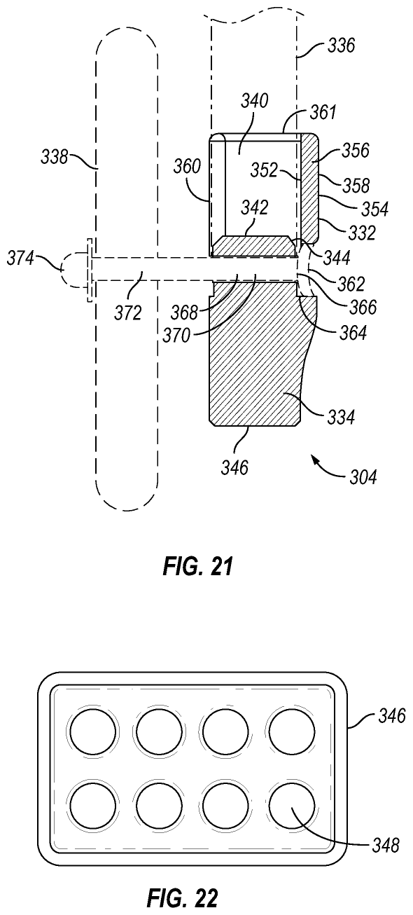

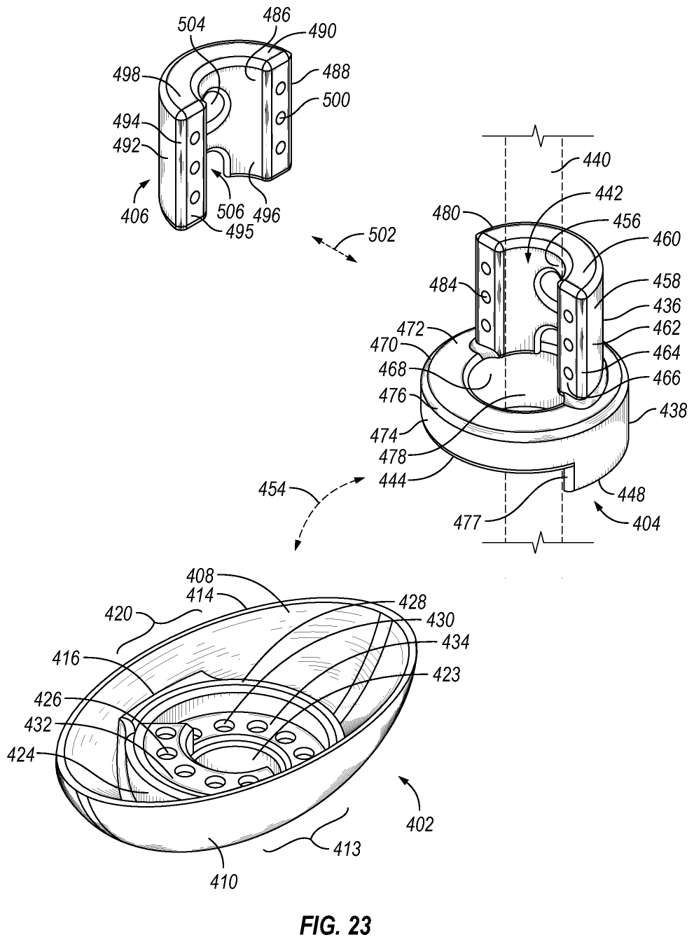

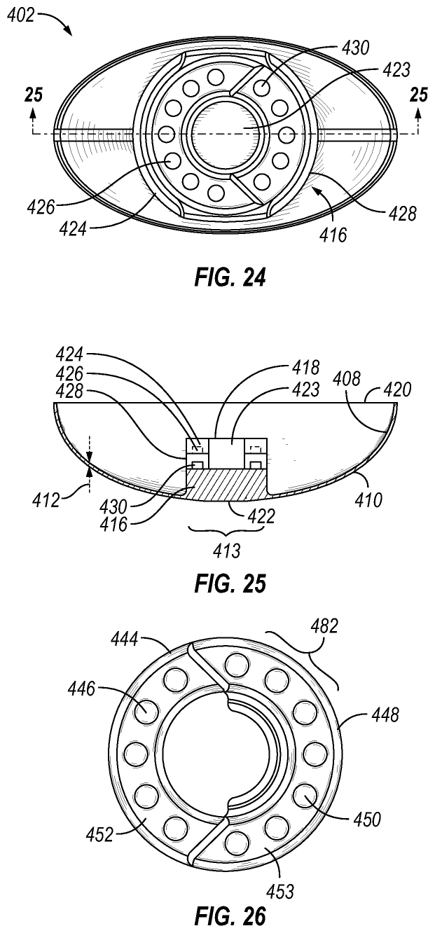

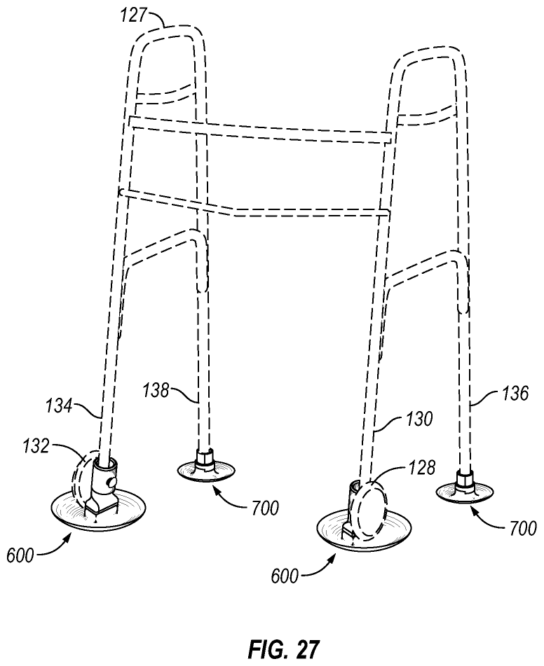

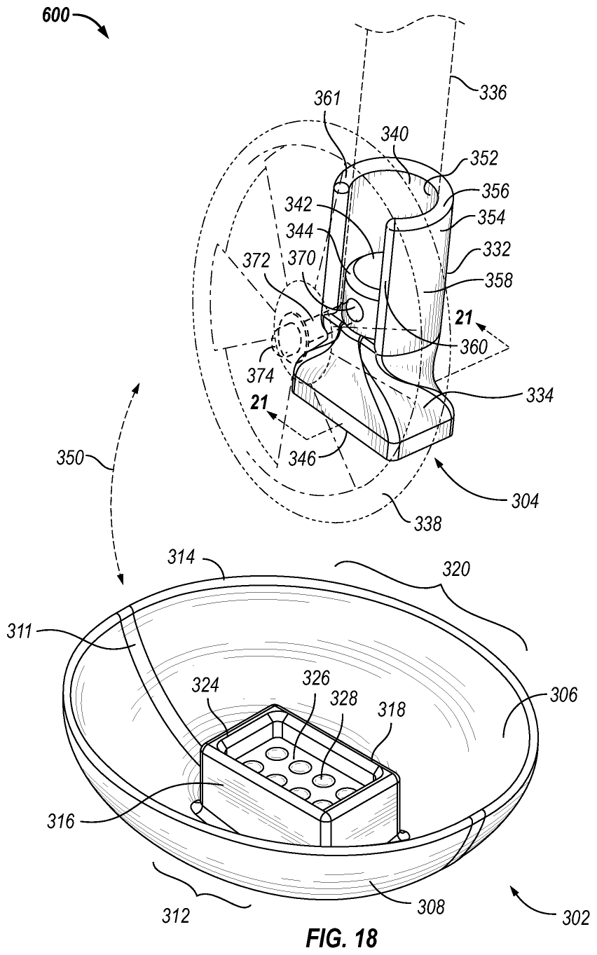

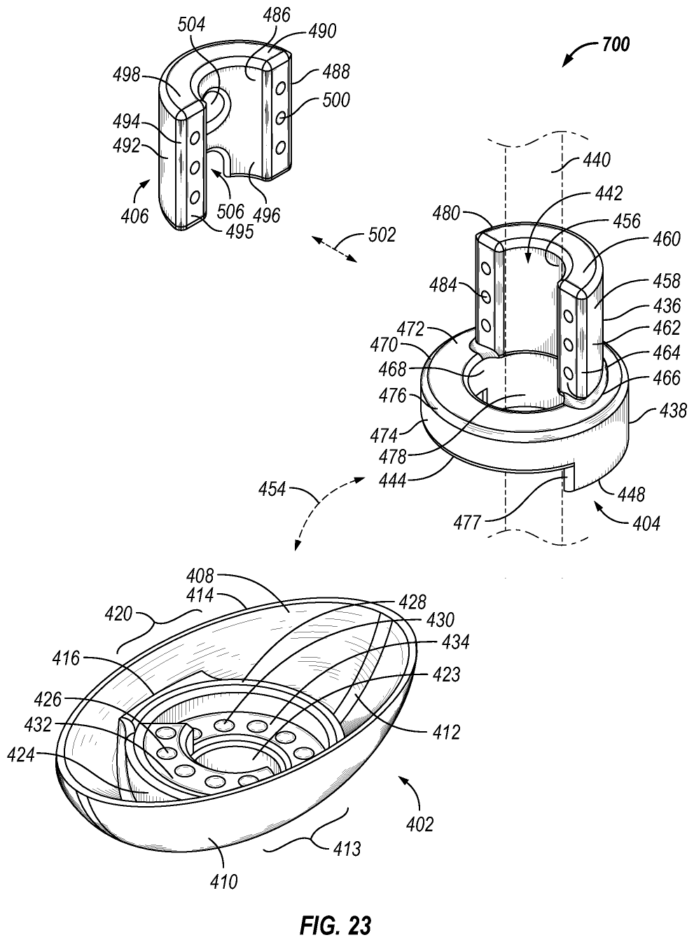

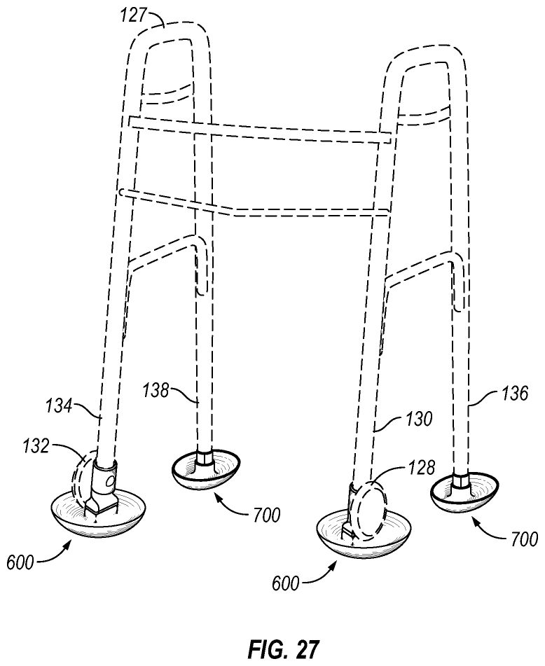

First apparatus 600, second apparatus 600, first apparatus 700, and second apparatus 700 as described herein were three-dimensionally (3D) printed using an Ender-3 3D printer with 100% infill using a 1.0 millimeter nozzle. The material was polyethylene terephthalate glycol-modified (PETG). A first leg-wheel attachment at the front right of a wheeled walker and a second leg-wheel attachment at the front left of the wheeled walker were removed. Releasably-connecting component 304 of first apparatus 600 was attached and releasably secured to the first leg-wheel attachment and releasably-connecting component 304 of second apparatus 600 was attached and releasably secured to the second leg-wheel attachment (see, for example, FIGS. 18, 21, and 27). A first leg attachment at the back right of the wheeled walker and a second leg attachment at the back left of the wheeled walker were removed. Releasably-connecting component 404 and releasably-securing component 406 of first apparatus 700 was attached and releasably secured to the first leg attachment and releasably-connecting component 404 and releasably-securing component 406 of second apparatus 700 was attached and releasably secured to the second leg attachment (see, for example, FIGS. 23 and 27). First leg-wheel attachment, second leg-wheel attachment, first leg attachment, and second leg attachment were then reattached to the wheeled walker using the push button height adjustments of the wheeled walker to provide for a modified wheeled walker comprising the releasably-connecting components.

The following procedure was used to compare the functionality of the modified wheeled walker comprising the releasably-connecting components before releasably connecting the four adapting components, i.e., the modified wheeled walker without the four adapting components, compared to the modified wheeled walker after releasably connecting the four adapting components, i.e., the modified wheeled walker with the four adapting components. Six participants of various height and weight were each taught how to use the modified wheeled walker before releasably connecting the four adapting components, how to releasably-connect and releasably-disconnect the four adapting components, and how to use the modified wheeled walker after releasably connecting the four adapting components. A short outdoor course comprising a sidewalk pavement, grass, and sand was prepared and marked. Each participant used the modified wheeled walker before releasably connecting the four adapting components to complete the course one time. Each participant then used the modified wheeled walker after releasably connecting the four adapting components to complete the course one more additional time. Each participant then releasably-connected and releasably-disconnected the four adapting components.

Each participant then completed a survey rating the performance of the modified wheeled walker before and after releasably connecting the four adapting components on a scale of 1 to 5 with 1 indicating the lowest performance rating and 5 indicating the highest performance rating. Regarding performance on sidewalk pavement, the modified wheeled walker scored an average of 4.33 before releasably connecting the four adapting components compared to an average of 2.67 after releasably connecting the four adapting components providing for a 1.66 decrease in functionality after releasably connecting the four adapting components. Regarding performance on grass, the modified wheeled walker scored an average of 2.83 before releasably connecting the four adapting components compared to an average of 3.67 after releasably connecting the four adapting components providing for a 0.84 improvement after releasably connecting the four adapting components. Regarding performance on sand, the modified wheeled walker scored an average of 2.00 before releasably connecting the four adapting components compared to an average of 3.50 after releasably connecting the four adapting components providing for a 1.50 improvement after releasably connecting the four adapting components. Regarding ease of changing directions, the modified wheeled walker scored an average of 2.83 before releasably connecting the four adapting components compared to an average of 3.00 after releasably connecting the four adapting components providing for a 0.17 improvement after releasably connecting the four adapting components. The participants also rated the ease of releasably connecting and releasably disconnecting the four adapting components as an average of 4.33. Generally observed results indicated that the modified wheeled walker was often hindered by the grass both before and after releasably connecting the four adapting components, but more so before releasably connecting the four adapting components. The modified wheeled walker before releasably connecting the four adapting components sunk into the sand, particularly when more weight was applied to the modified wheeled walker. After releasably connecting the four adapting components, the four adapting components helped to keep the modified wheeled walker higher in the sand, i.e., helped to prevent the modified wheeled walker from sinking into the sand. The modified wheeled walker generally functioned the same on the sidewalk pavement before releasably connecting the four adapting components compared to before releasably connecting the front two adapting components and after releasably connecting the back two adapting components. One participant removed the two front adapting components easily and unprompted upon reaching the sidewalk pavement. On both grass and sand, there was an improvement of the performance of the modified wheeled walker after releasably connecting the four adapting components. The testing also indicated an ease of transitioning between using the modified wheeled walker before releasably connecting the four adapting components, and using the modified wheeled walker after releasably connecting the four adapting components.

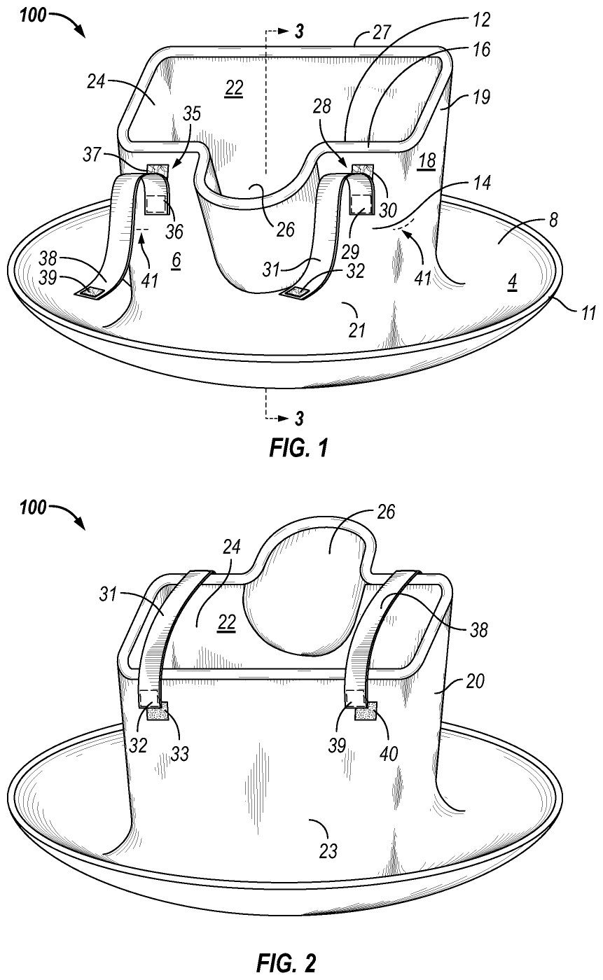

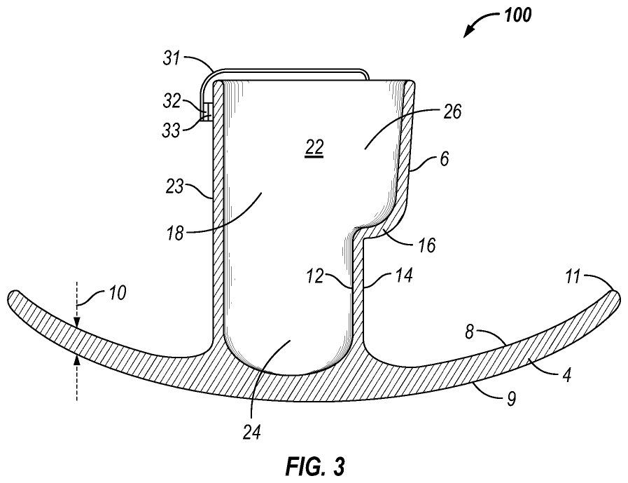

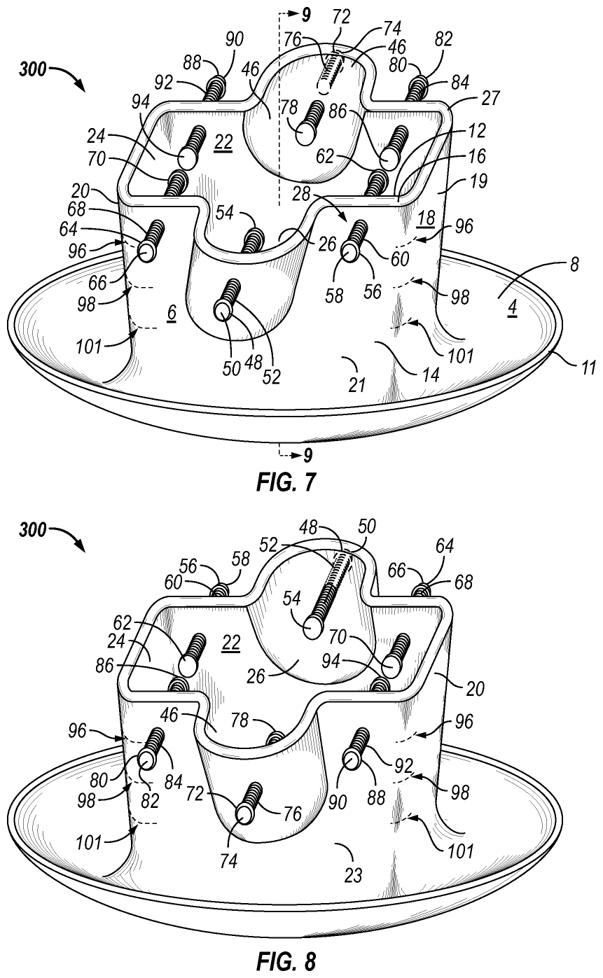

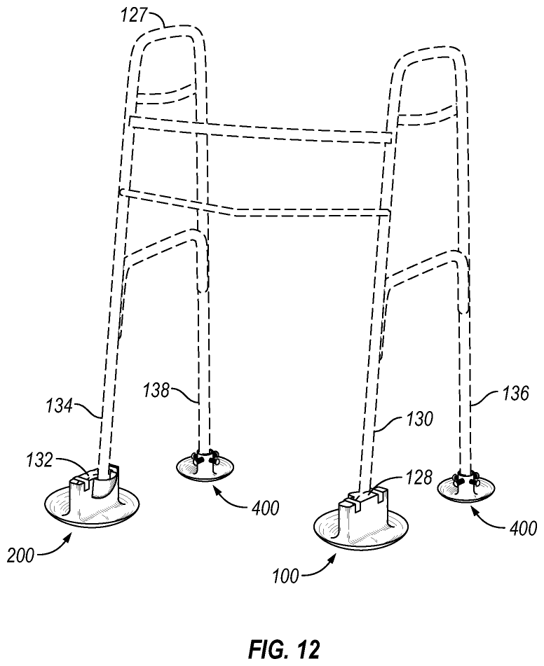

Referring to FIG. 1, an example embodiment of an apparatus 100 comprises an adapting component 4 and a releasably-connecting component 6. Adapting component 4 and releasably-connecting component 6 are shown as comprising one continuous component prepared by any suitable means as described herein. Adapting component 4 comprises a concave adapting component top surface 8. Adapting component 4 further comprises a convex adapting component bottom surface 9 providing for an adapting component thickness 10 (not shown, see FIG. 3). Adapting component 4 further comprises an edge component 11 comprising a generally hemispherical shape totally encompassing a perimeter of adapting component 4. Releasably-connecting component 6 comprises a generally cuboid shape. Releasably-connecting component 6 further comprises a releasably-connecting component inner surface 12 and a releasably-connecting component outer surface 14 providing for a releasably-connecting component thickness 16. Releasably-connecting component 6 further comprises a releasably-connecting component wall 18 comprising a front wall section 19, a back wall section 20 (not shown, see FIG. 2), a first side wall section 21, and a second side wall section 23 (not shown, see FIG. 2). Front wall section 19 and back wall section 21 are shown as substantially parallel and comprising substantially the same length. First side wall section 21 and second side wall section 23 are shown as substantially parallel and comprising substantially the same length. Releasably-connecting component wall 18 is shown as comprising one continuous component. Releasably-connecting component 6 further comprises a receiving space 22 comprising a receiving space first section 24 and a receiving space second section 26. Receiving space first section 24 comprises a generally ellipsoid shape to receive, for example, a wheel attached to a leg of a device (see, for example, FIG. 12). Receiving space second section 26 comprises a generally semiellipsoid shape to receive, for example, the leg attached to the wheel of the device (see, for example, FIG. 12). Receiving space second section 26 is shown as vertically angled and may, for example, be vertically straight. Receiving space 22 may further comprise a receiving space third section opposite of, and comprising a shape similar to, receiving space second section 26 (see, for example, receiving space third section 46 shown in FIG. 7 and FIG. 8). Releasably-connecting component 6 further comprises an upper perimeter 27. Upper perimeter 27 is shown as comprising one level. Upper perimeter 27 may comprise more than one level. Upper perimeter 27 may comprise an upper perimeter passageway (not shown) providing for a passageway for a feature of a device for example, a leg, a frame, a brake component, and combinations thereof.

Still referring to FIG. 1, apparatus 100 further comprises a first releasably-securing component 28 comprising a first hook-and-loop fastener located at a first releasably-securing location. First hook-and-loop fastener comprises a first part 29 and a corresponding second part and is shown after partially fastening first part 29 and a corresponding second part 30. First part 29 is connected to a first end of a first strap 31. First releasably-securing component 28 further comprises a second hook-and-loop fastener (not shown, see FIG. 2 and FIG. 3) located at a second releasably-securing location. Second hook-and-loop fastener comprises a first part 32 and a corresponding second part 33 (not shown, see FIG. 2 and FIG. 3) and is shown before fastening first part 32 and corresponding second part 33. Apparatus 100 further comprises a second releasably-securing component 35 comprising a third hook-and-loop fastener located at a third releasably-securing location. Third hook-and-loop fastener comprises a first part 36 and a corresponding second part 37 and is shown after partially fastening first part 36 and the corresponding second part 37. First part 36 is connected to a first end of a second strap 38. Second releasably-securing component 35 further comprises a fourth hook-and-loop fastener (not shown, see FIG. 2) located at a fourth releasably-securing location. Fourth hook-and-loop fastener comprises a first part 39 and a corresponding second part 40 and is shown before fastening first part 39 and the corresponding second part 40. A first part of a hook-and-loop fastener may comprise a hook and a second part of the hook-and-loop fastener may comprise a loop. Conversely, a first part of a hook-and-loop fastener may comprise a loop and a second part of the hook-and-loop fastener may comprise a hook. In lieu of first hook-and-loop fastener, second hook-and-loop fastener, third hook-and-loop fastener, fourth hook-and-loop fastener, and combinations thereof, first end of first strap 31, second end of first strap 31, first end of second strap 38, second end of second strap 38, and combinations thereof may be fixedly connected to releasably-connecting component 6 as described herein. The first parts and the corresponding second parts of the hook-and-loop fasteners are shown as generally small and square shaped. The first parts and the corresponding second parts of the hook-and-loop fasteners may comprise a generally larger and more elongated shape that may provide for a larger hook-and-loop fastener 34, and combinations thereof may be optional. In lieu of, or in addition to, first releasably-securing component 28, second releasably-securing component 35, and combinations thereof, a releasably-securing component as described herein may be utilized. The first releasably-securing location, the second releasably-securing location, the third releasably-securing location, the fourth releasably-securing location, and combinations thereof may be located at any location on adapting component 4, releasably-connecting component 6, and combinations thereof.

Still referring to FIG. 1, an optional cut line 41 is shown where the height of the releasably-connecting component 6 may be reduced. For example, upper perimeter 27 may be above a top of a wheel of a device when apparatus 100 is utilized. When the size of a wheel is larger, the height of releasably-connecting component 6 may need to be reduced to help provide for a reduction of the overall size of releasably-connecting component 6. For example, when the size of a wheel is larger, the height of releasably-connecting component 6 and upper perimeter 27 may be reduced to where upper perimeter 27 is below the top of the wheel. Also, for example, when the size of a wheel is even larger, the height of releasably-connecting component 6 and upper perimeter 27 may be reduced to cut line 41 where upper perimeter 27 is further below the top of the wheel, for example, about half-way down from the top of the wheel. Also, for example, when the size of a wheel is even larger, the height of releasably-connecting component 6 and upper perimeter 27 may be reduced to where upper perimeter 27 is even further below the top of the wheel, for example, about three-quarters of the way down from the top of the wheel. Examples of other various optional cut lines are shown in FIG. 7 and FIG. 8.

Referring to FIG. 2, an example embodiment of apparatus 100 is shown. FIG. 2 also shows back wall section 20 and second side wall section 23. FIG. 2 also shows second hook-and-loop fastener at the second releasably-securing location comprising first part 32 and corresponding second part 33 before fastening first part 32 and corresponding second part 33. FIG. 2 also shows fourth hook-and-loop fastener at the fourth releasably-securing location comprising first part 39 and corresponding second part 40 before fastening first part 39 and corresponding second part 40.

Referring to FIG. 3, apparatus 100 shown in FIG. 1 is shown in cross-section. FIG. 3 also 3 also shows second hook-and-loop fastener comprising first part 32 and corresponding second part 33 after fastening first part 32 and corresponding second part 33.

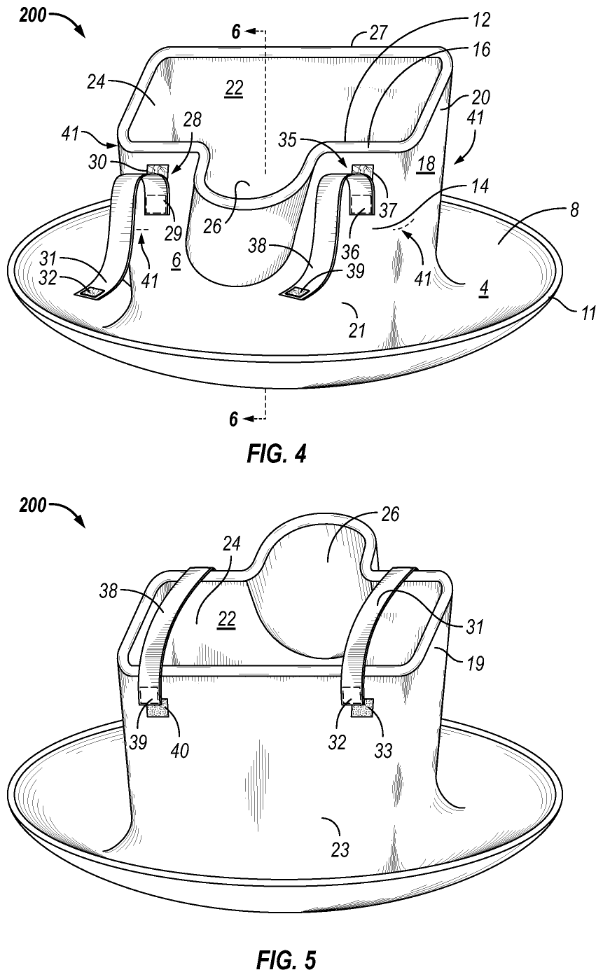

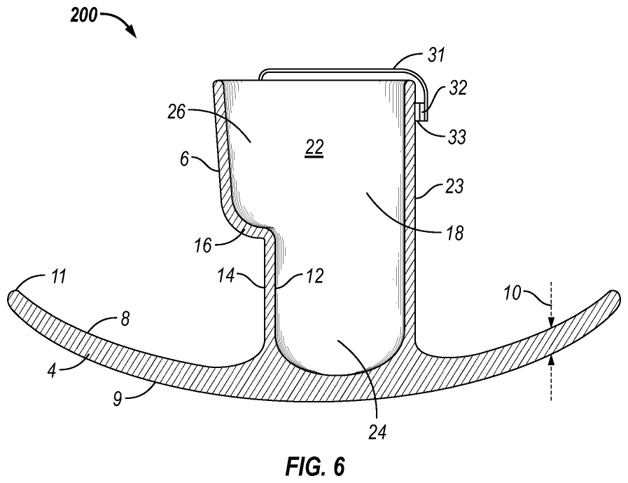

Referring to FIG. 4, an example embodiment of an apparatus 200 comprises adapting component 4 and releasably-connecting component 6. Adapting component 4 and releasably-connecting component 6 are shown as comprising one continuous component prepared by any suitable means as described herein. Adapting component 4 comprises concave adapting component top surface 8. Adapting component 4 further comprises convex adapting component bottom surface 9 providing for adapting component thickness 10 (not shown, see FIG. 6). Adapting component 4 further comprises an edge component 11 comprising a generally hemispherical shape totally encompassing a perimeter of adapting component 4. Releasably-connecting component 6 comprises a generally cuboid shape. Releasably-connecting component 6 further comprises releasably-connecting component inner surface 12 and releasably-connecting component outer surface 14 providing for releasably-connecting component thickness 16. Releasably-connecting component 6 further comprises releasably-connecting component wall 18 comprising front wall section 19 (not shown, see FIG. 5), back wall section 20, first side wall section 21, and second side wall section 23 (not shown, see FIG. 5). Front wall section 19 and back wall section 21 are shown as substantially parallel and comprising substantially the same length. First side wall section 21 and second side wall section 23 are shown as substantially parallel and comprising substantially the same length. Releasably-connecting component wall 18 is shown as comprising one continuous component. Also, for example, releasably-connecting component wall 18 may comprise separate components. Releasably-connecting component 6 further comprises receiving space 22 comprising receiving space first section 24 and receiving space second section 26. Receiving space first section 24 comprises a generally ellipsoid shape to receive, for example, a wheel attached to a leg of a device (see, for example, FIG. 12). Receiving space second section 26 comprises a generally semiellipsoid shape to receive, for example, the leg attached to the wheel of the device (see, for example, FIG. 12). Receiving space second section 26 is shown as vertically angled and may, for example, be vertically straight. Receiving space 22 may further comprise a receiving space third section opposite of, and comprising a shape similar to, receiving space second section 26 (see, for example, receiving space third section 46 shown in FIG. 7 and FIG. 8). Releasably-connecting component 6 further comprises upper perimeter 27. Upper perimeter 27 is shown comprising one level. Upper perimeter 27 may comprise more than one level. Upper perimeter 27 may comprise an upper perimeter passageway (not shown) providing for a passageway for a feature of a device for example, a leg, a frame, a brake component, and combinations thereof.

Still referring to FIG. 4, apparatus 200 further comprises a first releasably-securing component 28 comprising a first hook-and-loop fastener located at a first releasably-securing location. First hook-and-loop fastener comprises a first part 29 and a corresponding second part and is shown after partially fastening first part 29 and the corresponding second part 30. First part 29 is connected to a first end of a first strap 31. First releasably-securing component 28 further comprises a second hook-and-loop fastener (not shown, see FIG. 5 and FIG. 6) located at a second releasably-securing location. Second hook-and-loop fastener comprises a first part 32 and a corresponding second part 33 (not shown, see FIG. 5 and FIG. 6) and is shown before fastening first part 32 and corresponding second part 33. Apparatus 100 further comprises a second releasably-securing component 35 comprising a third hook-and-loop fastener located at a third releasably-securing location. Third hook-and-loop fastener comprises a first part 36 and a corresponding second part 37 and is shown after partially fastening first part 36 and the corresponding second part 37. First part 36 is connected to a first end of a second strap 38. Second releasably-securing component 35 further comprises a fourth hook-and-loop fastener (not shown, see FIG. 5) located at a fourth releasably-securing location. Fourth hook-and-loop fastener comprises a first part 39 and a corresponding second part 40 and is shown before fastening first part 39 and the corresponding second part 40. A first part of a hook-and-loop fastener may comprise a hook and a second part of the hook-and-loop fastener may comprise a loop. Conversely, a first part of a hook-and-loop fastener may comprise a loop and a second part of the hook-and-loop fastener may comprise a hook. In lieu of first hook-and-loop fastener, second hook-and-loop fastener, third hook-and-loop fastener, fourth hook-and-loop fastener, and combinations thereof, first end of first strap 31, second end of first strap 31, first end of second strap 38, second end of second strap 38, and combinations thereof may be fixedly connected to releasably-connecting component 6 as described herein. The first parts and the corresponding second parts of the hook-and-loop fasteners are shown as generally small and square shaped. The first parts and the corresponding second parts of the hook-and-loop fasteners may comprise a generally larger and more elongated shape that may provide for a larger hook-and-loop fastener 34, and combinations thereof may be optional. In lieu of, or in addition to, first releasably-securing component 28, second releasably-securing component 35, and combinations thereof, a releasably-securing component as described herein may be utilized. The first releasably-securing location, the second releasably-securing location, the third releasably-securing location, the fourth releasably-securing location, and combinations thereof may be located at any location on adapting component 4, releasably-connecting component 6, and combinations thereof.

Still referring to FIG. 4, an optional cut line 41 is shown where the height of the releasably-connecting component 6 may be reduced. For example, upper perimeter 27 may be above a top of a wheel of a device when apparatus 200 is utilized. When the size of a wheel is larger, the height of releasably-connecting component 6 may need to be reduced to help provide for a reduction of the overall size of releasably-connecting component 6. For example, when the size of a wheel is larger, the height of releasably-connecting component 6 and upper perimeter 27 may be reduced to where upper perimeter 27 is below the top of the wheel. Also, for example, when the size of a wheel is even larger, the height of releasably-connecting component 6 and upper perimeter 27 may be reduced to cut line 41 where upper perimeter 27 is further below the top of the wheel, for example, about half-way down from the top of the wheel. Also, for example, when the size of a wheel is even larger, the height of releasably-connecting component 6 and upper perimeter 27 may be reduced to where upper perimeter 27 is even further below the top of the wheel, for example, about three-quarters of the way down from the top of the wheel. Examples of other various optional cut lines are shown in FIG. 7 and FIG. 8.

Referring to FIG. 5, an example embodiment of apparatus 200 is shown. FIG. 5 also shows front wall section 19 and second side wall section 23. FIG. 5 also shows second hook-and-loop fastener at the second releasably-securing location comprising first part 32 and corresponding second part 33 before fastening first part 32 and corresponding second part 33. FIG. 5 also shows fourth hook-and-loop fastener at the fourth releasably-securing location comprising first part 39 and corresponding second part 40 before fastening first part 39 and corresponding second part 40.

Referring to FIG. 6, apparatus 200 shown in FIG. 4 is shown in cross-section. FIG. 6 also 6 also shows second hook-and-loop fastener comprising first part 32 and corresponding second part 33 after fastening first part 32 and corresponding second part 33.

When receiving space second section 26 comprises a vertically straight shape, apparatus 200 shown in FIG. 4 may be provided, for example, by rotating apparatus 100 shown in FIG. 1 one-hundred and eighty (180) degrees. Also, vice versa, when receiving space second section 26 comprises a vertically straight shape, apparatus 100 shown in FIG. 1 can be provided, for example, by rotating apparatus 200 shown in FIG. 4 one-hundred and eighty (180) degrees.

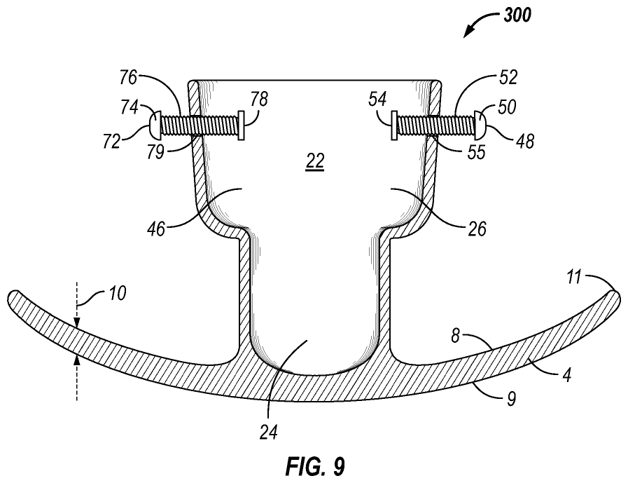

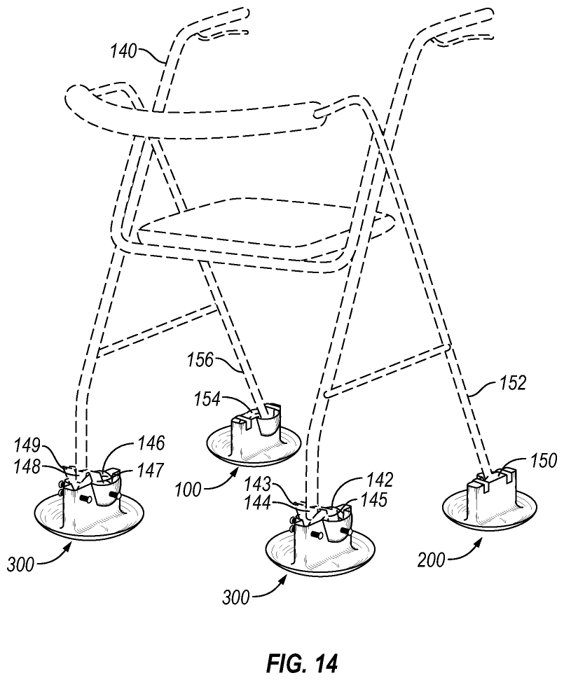

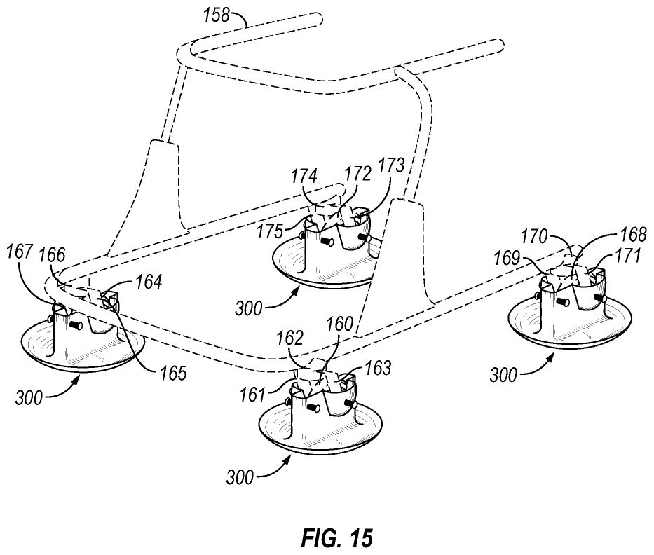

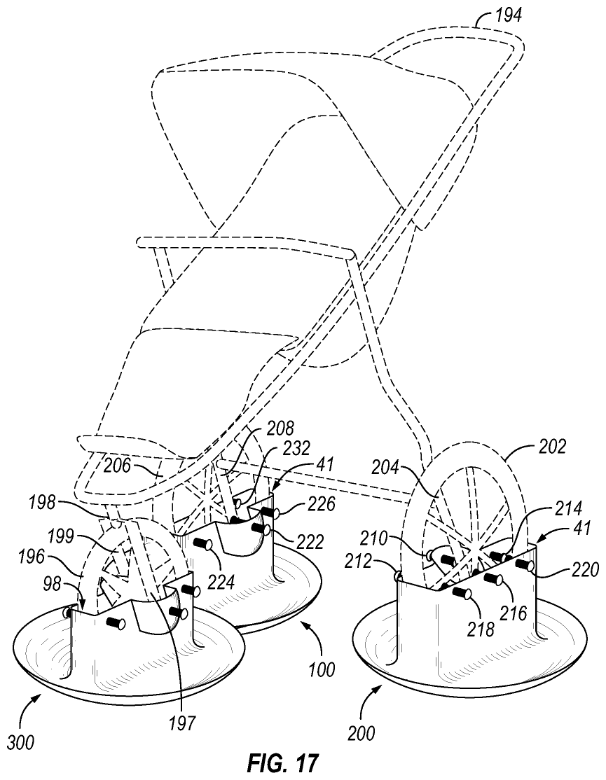

Referring to FIG. 7 and FIG. 8, an example embodiment of an apparatus 300 comprises adapting component 4 and releasably-connecting component 6. Adapting component 4 and releasably-connecting component 6 are shown as comprising one continuous component prepared by any suitable means as described herein. Adapting component 4 comprises concave adapting component top surface 8. Adapting component 4 further comprises convex adapting component bottom surface 9 and adapting component thickness 10 (not shown, see FIG. 9). Adapting component 4 further comprises edge component 11 comprising a generally hemispherical shape totally encompassing a perimeter of adapting component 4. Releasably-connecting component 6 comprises a generally cuboid shape. Releasably-connecting component 6 further comprises releasably-connecting component inner surface 12 and releasably-connecting component outer surface 14 providing for releasably-connecting component thickness 16. Releasably-connecting component 6 further comprises releasably-connecting component wall 18 comprising a front wall section 19, a back wall section 20, a first side wall section 21, and a second side wall section 23. Front wall section 19 and back wall section 21 are shown as substantially parallel and comprising substantially the same length. First side wall section 21 and second side wall section 23 are shown as substantially parallel and comprising substantially the same length. Releasably-connecting component wall 18 is shown as comprising one continuous component. Also, for example, releasably-connecting component wall 18 may comprise separate components. Releasably-connecting component 6 further comprises receiving space 22 comprising receiving space first section 24, receiving space second section 26, and a receiving space third section 46. Receiving space first section 24 comprises a generally ellipsoid shape to receive, for example, a wheel attached to a frame of a device (see, for example, FIG. 14, FIG. 15, and FIG. 17). Receiving space second section 26 comprises a generally semiellipsoid shape to receive, for example, a first section of the frame attached to the wheel of the device (see, for example, FIG. 14, FIG. 15, and FIG. 17). Receiving space third section 46 comprises a generally semiellipsoid shape to receive, for example, a second section of the frame attached to the wheel of the device (see, for example, FIG. 14, FIG. 15, and FIG. 17). While receiving space second section 26 and receiving space third section 46 are shown comprising shapes that are angled in a back direction towards back wall section 20, the shapes may be angled in a forward direction towards front wall section 19 by rotating apparatus 300 shown in FIG. 7 one-hundred and eighty (180) degrees. Releasably-connecting component 6 further comprises upper perimeter 27. Upper perimeter 27 is shown comprising one level. Upper perimeter 27 may comprise more than one level. Upper perimeter 27 may comprise an upper perimeter passageway (not shown) providing for a passageway for a feature of a device for example, a leg, a frame, a foot brake component, and combinations thereof.

Still referring to FIG. 7 and FIG. 8, apparatus 300 further comprises a releasably-securing component, at a first releasably-securing location, comprising a first screw knob fastener 48 comprising a first knob 50, a first screw 52, and a first contacting component 54. First screw 52 passes through a first grooved passageway 55 (not shown, see FIG. 9). Apparatus 300 further comprises a releasably-securing component, at a second releasably-securing location, comprising a second screw knob fastener 56 comprising a second knob 58, a second screw 60, and a second contacting component 62. Apparatus 300 further comprises a releasably-securing component, at a third releasably-securing location, comprising a third screw knob fastener 64 comprising a third knob 66, a third screw 68, and a third contacting component 70. Apparatus 300 further comprises a releasably-securing component, at a fourth releasably-securing location, comprising a fourth screw knob fastener 72 comprising a fourth knob 74, a fourth screw 76, and a fourth contacting component 78. Fourth screw 76 passes through a second grooved passageway 79 (not shown, see FIG. 9). Apparatus 300 further comprises a releasably-securing component, at a fifth releasably-securing location, comprising a fifth screw knob fastener 80 comprising a fifth knob 82, a fifth screw 84, and a fifth contacting component 86. Apparatus 300 further comprises a releasably-securing component, at a sixth releasably-securing location, comprising a sixth screw knob fastener 88 comprising a sixth knob 90, a sixth screw 92, and a sixth contacting component 94. Second screw 60, third screw 68, fifth screw 84, and sixth screw 92 each pass through a respective grooved passageway (not shown) similar to first grooved passageway 55 and second grooved passageway 79. For example, first contacting component 54 and fourth contacting component 78 may contact a frame of a caster wheel, a frame of a double-wheel caster, and combinations thereof. Also, for example, second contacting component 62, third contacting component 70, fifth contacting component 86, and sixth contacting component 94 may contact a caster wheel, a wheel of a double-wheel caster, and combinations thereof. Screw knob fasteners 48, 56, 64, 72, 80, 88, and combinations thereof may be optional. In lieu of, or in addition to, screw knob fasteners 48, 56, 64, 72, 80, 88, and combinations thereof, a releasably-securing component as described herein may be utilized. The first releasably-securing location, the second releasably-securing location, the third releasably-securing location, the fourth releasably-securing location, the fifth releasably-securing location, the sixth releasably-securing location, and combinations thereof may be located at any location on releasably-connecting component 6. Turning a knob of a screw knob fastener may provide for a releasably contacting, a releasably separating, a traversing, and combinations thereof of an end of a screw or a contacting component connected at an end of a screw as described herein.

Still referring to FIG. 7 and FIG. 8, while not shown, for example, a screw and, when present, a contacting component, of a screw knob fastener may be located above a wheel, between a first spoke of a wheel and a second spoke of a wheel, and combinations thereof. While not shown, a screw, and generally without a contacting component, of a screw knob fastener may be located at or near a frame passageway of a frame of a device. A frame passageway may be provided by any means known in the art, for example, by drilling. A frame passageway may pass through the frame, partially through the frame, and combinations thereof. For example, first screw 52 and generally without first contacting component 54 may contact a frame passageway. Similarly, fourth screw 76 and generally without fourth contacting component 78 may contact a frame passageway. For example, first screw 52 and generally without first contacting component 54 may traverse the frame passageway, releasably contact fourth screw 76 and generally without fourth contacting component 78, releasably separate from fourth screw 76, and combinations thereof. Similarly, for example, fourth screw 76 and generally without fourth contacting component 78 may traverse the frame passageway, releasably contact first screw 52 and generally without first contacting component 54, releasably separate from first screw 52, and combinations thereof. Also, for example, first screw 52 and generally without first contacting component 54, and in lieu of fourth screw knob fastener 72, may traverse the frame passageway, releasably contact the second side wall section 23 at the fourth releasably-securing location, releasably separate from the second side wall section 23 at the fourth releasably-securing location, and combinations thereof. Also, for example, fourth screw 76 and generally without fourth contacting component 78, and in lieu of first screw knob fastener 48, may traverse the frame passageway, releasably contact the first side wall section 21 at the first releasably-securing location, releasably separate from the first side wall section 21 at the first releasably-securing location, and combinations thereof.

Still referring to FIG. 7 and FIG. 8, while not shown, for example, second screw 60 and second contacting component 62 may traverse, releasably contact fifth screw 84 and fifth contacting component 86, releasably separate from fifth screw 84 and fifth contacting component 86, and combinations thereof. Similarly, for example, fifth screw 84 and fifth contacting component 86 may traverse, releasably contact second screw 60 and second contacting component 62, releasably separate from second screw 60 and second contacting component 62, and combinations thereof. Also, for example, third screw 68 and third contacting component 70 may traverse, releasably contact sixth screw 92 and sixth contacting component 94, releasably separate from sixth screw 92 and sixth contacting component 94, and combinations thereof. Similarly, for example, sixth screw 92 and sixth contacting component 94 may traverse, releasably contact third screw 68 and third contacting component 70, releasably separate from third screw 68 and third contacting component 70, and combinations thereof. Also, for example, second screw 60 and second contacting component 62, and in lieu of fifth screw knob fastener 80, may traverse, releasably contact the second side wall section 23 at the fifth releasably-securing location, releasably separate from the second side wall section 23 at the fifth releasably-securing location, and combinations thereof. Similarly, for example, third screw 68 and third contacting component 70, and in lieu of sixth screw knob fastener 88, may traverse, releasably contact the second side wall section 23 at the sixth releasably-securing location, releasably separate from the second side wall section 23 at the sixth releasably-securing location, and combinations thereof. Similarly, while not shown, for example, fifth screw 84 and fifth contacting component 86, and in lieu of second screw knob fastener 56, may traverse, releasably contact the first side wall section 21 at the second releasably-securing location, releasably separate from the first side wall section 21 at the second releasably-securing location, and combinations thereof. Similarly, while not shown, for example, sixth screw 92 and sixth contacting component 94, and in lieu of third screw knob fastener 64, may traverse, releasably contact the first side wall section 21 at the third releasably-securing location, releasably separate from the first side wall section 21 at the third releasably-securing location, and combinations thereof. The first releasably-securing location, the second releasably-securing location, the third releasably-securing location, the fourth releasably-securing location, the fifth releasably-securing location, the sixth releasably-securing location, and combinations thereof may each comprise a wall section, a wall indentation as described herein, a wall passageway (generally when the screw knob fastener does not comprise the contacting component) as described herein, and combinations thereof.

Still referring to FIG. 7 and FIG. 8, optional cut lines 96, 98, and 101 are shown where the height of releasably-connecting component 6 may be reduced. For example, upper perimeter 27 may be above a top of a wheel of a device when apparatus 300 is utilized. When the size of a wheel is larger, the height of releasably-connecting component 6 may need to be reduced to help provide for a reduction of the overall size of releasably-connecting component 6. For example, when the size of a wheel is larger, the height of releasably-connecting component 6 and upper perimeter 27 may be reduced to cut line 96 where upper perimeter 27 is below the top of the wheel. Also, for example, when the size of a wheel is even larger, the height of releasably-connecting component 6 and upper perimeter 27 may be reduced to cut line 98 where upper perimeter 27 is further below the top of the wheel, for example, about half-way down from the top of the wheel. Also, for example, when the size of a wheel is even larger, the height of releasably-connecting component 6 and upper perimeter 27 may be reduced to cut line 101 where upper perimeter 27 is even further below the top of the wheel, for example, about three-quarters of the way down from the top of the wheel.

Referring to FIG. 9, apparatus 300 shown in FIG. 7 is shown in cross-section. FIG. 9 also shows convex adapting component bottom surface 9 and adapting component thickness 10. FIG. 9 also shows first grooved wall passageway 55 and second grooved wall passageway 79.

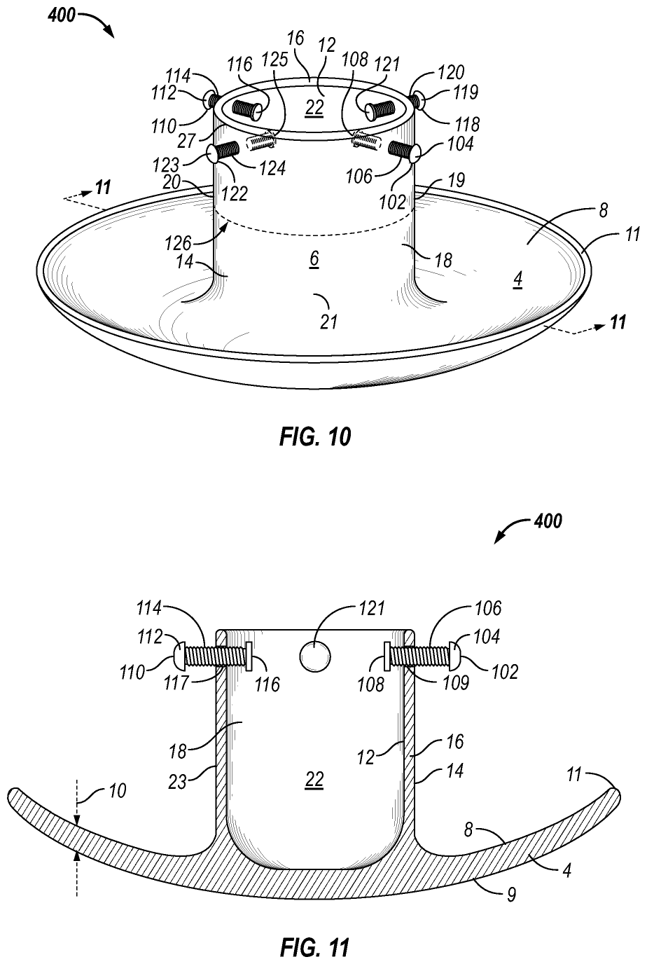

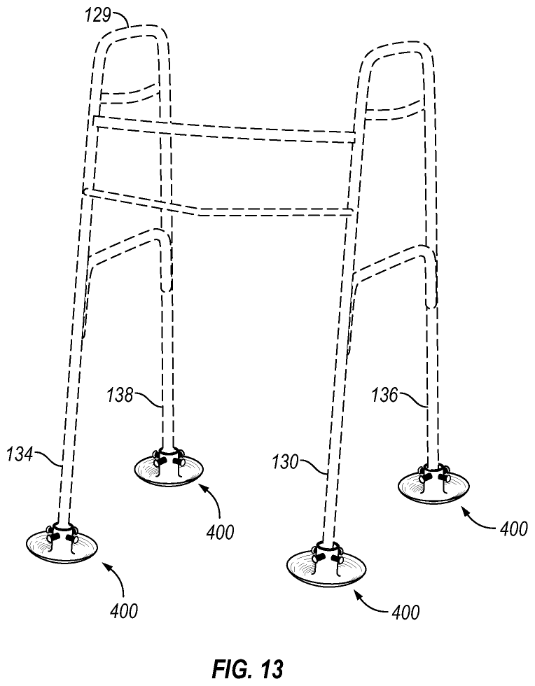

Referring to FIG. 10, an example embodiment of apparatus 400 comprises adapting component 4 and releasably-connecting component 6. Adapting component 4 and releasably-connecting component 6 are shown as comprising one continuous component prepared by any suitable means as described herein. Adapting component 4 comprises concave adapting component top surface 8. Adapting component 4 further comprises convex adapting component bottom surface 9 and adapting component thickness 10 (not shown, FIG. 11). Adapting component 4 further comprises edge component 11 comprising a generally hemispherical shape totally encompassing a perimeter of adapting component 4. Releasably-connecting component 6 comprises a generally cylindrical shape. Releasably-connecting component 6 further comprises releasably-connecting component inner surface 12 and releasably-connecting component outer surface 14 providing for releasably-connecting component thickness 16. Releasably-connecting component 6 further comprises releasably-connecting component wall 18 comprising front wall section 19, back wall section 20, first side wall section 21, and second side wall section 23 (not shown, see FIG. 11). Front wall section 19 and back wall section 21 are shown as substantially parallel and comprising substantially the same length. First side wall section 21 and second side wall section 23 are shown as substantially parallel and comprising substantially the same length. Releasably-connecting component wall 18 is shown as comprising one continuous component. Also, for example, releasably-connecting component wall 18 may comprise separate components. Releasably-connecting component 6 further comprises receiving space 22. Receiving space 22 comprises a generally cylindroid shape to receive, for example, a leg of a device (see, for example, FIG. 12 and FIG. 13). Releasably-connecting component 6 comprising receiving space 22 is shown as vertically straight and may, for example, be vertically angled. For example, releasably-connecting component 6 comprising receiving space 22 may be vertically angled generally in a direction towards front wall section 19, back wall section 20, first sidewall section 21, or second sidewall section 23. Releasably-connecting component 6 further comprises upper perimeter 27. Upper perimeter 27 is shown comprising one level. Upper perimeter 27 may comprise more than one level. Upper perimeter 27 may comprise an upper perimeter passageway (not shown) providing for a passageway for a feature of a device for example, a leg, a frame, a foot brake component, and combinations thereof.

Still referring to FIG. 10, apparatus 400 further comprises a releasably-securing component, at a first releasably-securing location, comprising a seventh screw knob fastener 102 comprising a seventh knob 104, a seventh screw 106, and a seventh contacting component 108. Seventh screw 106 passes through a third grooved passageway 109 (not shown, see FIG. 11). Apparatus 400 further comprises a releasably-securing component, at a second releasably-securing location, comprising an eighth screw knob fastener 110 comprising an eighth knob 112, an eighth screw 114, and an eighth contacting component 116. Eighth screw 114 passes through a fourth grooved passageway 117 (not shown, see FIG. 11). Apparatus 400 further comprises a releasably-securing component, at a third releasably-securing location, comprising a ninth screw knob fastener 118 comprising a ninth knob 119, a ninth screw 120, and a ninth contacting component 121. Apparatus 400 further comprises a releasably-securing component, at a fourth releasably-securing location, comprising a tenth screw knob fastener 122 comprising a tenth knob 123, a tenth screw 124, and a tenth contacting component 125. Ninth screw 120 and tenth screw 124 each pass through a respective grooved passageway (not shown) similar to third grooved passageway 109 and fourth grooved passageway 117. Screw knob fasteners 102, 110, 118, 122, and combinations thereof may be optional. In lieu of, or in addition to, screw knob fasteners 102, 110, 118, 122, and combinations thereof, a releasably-securing component as described herein may be utilized. The first releasably-securing location, the second releasably-securing location, the third releasably-securing location, the fourth releasably-securing location, and combinations thereof may be located at any location on releasably-connecting component 6. Turning a knob of a screw knob fastener may provide for a releasably contacting, a releasably separating, a traversing, and combinations thereof of an end of a screw or a contacting component connected at an end of a screw as described herein.

Still referring to FIG. 10, while not shown, for example, a screw and generally without a contacting component, of a screw knob fastener may be located at or near a leg passageway of a leg of a device. A leg passageway may be provided by any means known in the art, for example, by drilling. A leg passageway may pass through the leg, partially through the leg, and combinations thereof. For example, while not shown, seventh screw 106 and generally without seventh contacting component 108 may contact a leg passageway. Similarly, while not shown, eighth screw 114 and generally without eighth contacting component 116 may contact a leg passageway. For example, seventh screw 106 and generally without seventh contacting component 108 may traverse the leg passageway, releasably contact eighth screw 114 and generally without eighth contacting component 116, releasably separate from eighth screw 114, and combinations thereof. Similarly, for example, eight screw 114 and generally without eighth contacting component 116 may traverse the leg passageway, releasably contact seventh screw 106 and generally without seventh contacting component 108, releasably separate from seventh screw 106, and combinations thereof. Also, for example, while not shown, ninth screw 120 and generally without ninth contacting component 121 may contact a leg passageway. Similarly, while not shown, tenth screw 124 and generally without tenth contacting component 125 may contact a leg passageway. For example, ninth screw 120 and generally without ninth contacting component 121 may traverse the leg passageway, releasably contact tenth screw 124 and generally without tenth contacting component 125, releasably separate from tenth screw 124, and combinations thereof. Similarly, for example, tenth screw 124 and generally without tenth contacting component 125 may traverse the leg passageway, releasably contact ninth screw 120 and generally without ninth contacting component 121, releasably separate from ninth screw 120, and combinations thereof.

Still referring to FIG. 10, while not shown, for example, seventh screw 106 and generally without seventh contacting component 108, and in lieu of eighth screw knob fastener 110, may traverse the leg passageway, releasably contact the second side wall section 23 at the second releasably-securing location, releasably separate the second side wall section 23 at the second releasably-securing location, and combinations thereof. Also, for example, eighth screw 114 and generally without eighth contacting component 116, and in lieu of seventh screw knob fastener 102, may traverse the leg passageway, releasably contact the first side wall section 21 at the first releasably-securing location, releasably separate from the first side wall section 21 at the first releasably-securing location, and combinations thereof. Similarly, while not shown, ninth screw 120 and generally without ninth contacting component 121 may contact a leg passageway. Also, for example, ninth screw 120 and generally without ninth contacting component 121, and in lieu of tenth screw knob fastener 122, may traverse the leg passageway, releasably contact the back wall section 20 at the fourth releasably-securing location, releasably separate from the back wall section 20 at the fourth releasably-securing location, and combinations thereof. Similarly, while not shown, tenth screw 124 and generally without tenth contacting component 125 may contact a leg passageway. Also, for example, tenth screw 124 and generally without tenth contacting component 125, and in lieu of ninth screw knob fastener 118, may traverse the leg passageway, releasably contact the front wall section 19 at the third releasably-securing location, releasably separate from the front wall section 19 at the third releasably-securing location, and combinations thereof. The first releasably-securing location, the second releasably-securing location, the third releasably-securing location, the fourth releasably-securing location, and combinations thereof may each comprise a wall section, a wall indentation as described herein, a wall passageway (generally when the screw knob fastener does not comprise the contacting component) as described herein, and combinations thereof.

Still referring to FIG. 10, optional cut line 126 is shown where the height of releasably-connecting component 6 may be reduced. For example, the height of releasably-connecting component 6 may need to be reduced to help provide for a reduction of the overall size of releasably-connecting component 6. For example, the height of releasably-connecting component 6 and upper perimeter 27 may be reduced to cut line 126. Examples of other various optional cut lines are shown in FIG. 7 and FIG. 8.

Referring to FIG. 11, apparatus 400 shown in FIG. 10 is shown in cross-section. FIG. 11 also shows convex adapting component bottom surface 9 and adapting component thickness 10. FIG. 11 also shows second side wall section 23. FIG. 11 also shows third grooved wall passageway 109 and fourth grooved wall passageway 117.

Referring to FIG. 12, example embodiments of an apparatus of the invention are shown being utilized on a device comprising a wheeled walker 127. Wheeled walker 127 comprises a first wheel 128 attached to a first leg 130. A first apparatus 100 is shown after releasably connecting to first wheel 128 and first leg 130 and releasably securing. Wheeled walker 127 further comprises a second wheel 132 attached to a second leg 134. A first apparatus 200 is shown after releasably connecting to second wheel 132 and second leg 134 and releasably securing. Wheeled walker 127 further comprises a third leg 136. A first apparatus 400 is shown after releasably connecting to third leg 136 and releasably securing. Wheeled walker 127 further comprises a fourth leg 138. A second apparatus 400 is shown after releasably connecting to fourth leg 138 and releasably securing. First wheel 128, second wheel 132, and combinations thereof may comprise solid wheels, spoked wheels, and combinations thereof. One or more of the releasably-securing components may contact a leg, a wheel, a spoke of a wheel, pass between a spoke of a wheel and an adjacent spoke of the wheel, and combinations thereof.

Still referring to FIG. 12, first leg 130 and second leg 134 are shown as attached to an inside of first wheel 128 and an inside of second wheel 132, respectively. First leg 130 and second leg 134 may be attached to an outside of first wheel 128 and an outside of second wheel 132, respectively. When first leg 130 and second leg 134 are attached to the outside of first wheel 128 and the outside of second wheel 132, respectively, first apparatus 100 and first apparatus 200 may be switched so that first apparatus 100 may releasably connect to second wheel 132 and second leg 134 and releasably secure and first apparatus 200 may releasably connect to first wheel 128 and first leg 130 and releasably secure. Apparatus 300 shown in FIG. 7 may be utilized in lieu of first apparatus 100, second apparatus 200, and combinations thereof.

Referring to FIG. 13, example embodiments of an apparatus of the invention are shown being utilized on a device comprising a walker 129. Walker 129 comprises first leg 130. A third apparatus 400 is shown after releasably connecting to first leg 130 and releasably securing. Walker 129 further comprises second leg 134. A fourth apparatus 400 is shown after releasably connecting to second leg 134 and releasably securing. Walker 129 further comprises third leg 136. A fifth apparatus 400 is shown after releasably connecting to third leg 136 and releasably securing. Walker 129 further comprises fourth leg 138. A sixth apparatus 400 is shown after releasably connecting to fourth leg 138 and releasably securing.

Referring to FIG. 14, example embodiments of an apparatus of the invention are shown being utilized on a device comprising a rollator walker 140. Rollator walker 140 comprises a first caster wheel 142 attached to a first frame 144 comprising a first frame section 143 and a second frame section 145. A first apparatus 300 is shown after releasably connecting to first caster wheel 142 and first frame 144 and releasably securing. Rollator walker 140 further comprises a second caster wheel 146 attached to a second frame 148 comprising a third frame section 147 and a fourth frame section 149. A second apparatus 300 is shown after releasably connecting to second caster wheel 146 and second frame 148 and releasably securing. Rollator walker 140 further comprises a third wheel 150 attached to a fifth leg 152. A second apparatus 200 is shown after releasably connecting to third wheel 150 and fifth leg 152 and releasably securing. Second apparatus 200 may be provided by rotating apparatus 200 shown in FIG. 4 one-hundred and eighty (180) degrees. Rollator walker 140 further comprises a fourth wheel 154 attached to a sixth leg 156. A second apparatus 100 is shown after releasably connecting to fourth wheel 154 and sixth leg 156 and releasably securing. Second apparatus 100 may be provided by rotating apparatus 100 shown in FIG. 1 one-hundred and eighty (180) degrees. While not shown, first caster wheel 142, second caster wheel 146, third wheel 150, fourth wheel 154, and combinations thereof may further comprise a brake component, for example, a hand brake component, a foot brake component, and combinations thereof where the brake component has been engaged. First caster wheel 142, second caster wheel 146, third wheel 150, fourth wheel 154, and combinations thereof may comprise solid wheels, spoked wheels, and combinations thereof. One or more of the releasably-securing components may contact a wheel, a spoke of a wheel, pass between a spoke of a wheel and an adjacent spoke of the wheel, and combinations thereof.

Still referring to FIG. 14, fifth leg 152 and sixth leg 156 are shown as attached to an inside of third wheel 150 and an inside of fourth wheel 154, respectively. Fifth leg 152 and sixth leg 156 may be attached to an outside of third wheel 150 and an outside of fourth wheel 154, respectively. When fifth leg 152 and sixth leg 156 are attached to the outside of third wheel 150 and the outside of fourth wheel 154, respectively, second apparatus 200 and second apparatus 100 may be switched so that second apparatus 100 may releasably connect to third wheel 150 and fifth leg 152 and releasably secure and second apparatus 200 may releasably connect to fourth wheel 154 and sixth leg 156 and releasably secure. Apparatus 300 shown in FIG. 7 may be utilized in lieu of second apparatus 100, second apparatus 200, and combinations thereof. In lieu of rollator walker 140, a device, for example, a gait trainer or a stroller, comprising a configuration of caster wheels, frames, wheels, and legs as described herein for rollator walker 140, may be utilized.

Referring to FIG. 15, example embodiments of an apparatus of the invention are shown being utilized on a device comprising a gait trainer 158. Gait trainer 158 comprises a third caster wheel 160 attached to a third frame 162 comprising a fifth frame section 161 and a sixth frame section 163. A third apparatus 300 is shown after releasably connecting to third caster wheel 160 and third frame 162 and releasably securing. Gait trainer 158 further comprises a fourth caster wheel 164 attached to a fourth frame 166 comprising a seventh frame section 165 and an eighth frame section 167. A fourth apparatus 300 is shown after releasably connecting to fourth caster wheel 164 and fourth frame 166 and releasably securing. Gait trainer 158 further comprises a fifth caster wheel 168 attached to a fifth frame 170 comprising a ninth frame section 169 and a tenth frame section 171. A fifth apparatus 300 is shown after releasably connecting to fifth caster wheel 168 and fifth frame 170 and releasably securing. Gait trainer 158 further comprises a sixth caster wheel 172 attached to a sixth frame 174 comprising an eleventh frame section 173 and a twelfth frame section 175. A sixth apparatus 300 is shown after releasably connecting to sixth caster wheel 172 and sixth frame 174 and releasably securing. While not shown, third caster wheel 160, fourth caster wheel 164, fifth caster wheel 168, sixth caster wheel 172, and combinations thereof may further comprise a brake component, for example, a hand brake component, a foot brake component, and combinations thereof where the brake component has been engaged. Third caster wheel 160, fourth caster wheel 164, fifth caster wheel 168, sixth caster wheel 172, and combinations thereof may comprise solid wheels, spoked wheels, and combinations thereof. One or more of the releasably-securing components may contact a wheel, a spoke of a wheel, pass between a spoke of a wheel and an adjacent spoke of the wheel, and combinations thereof.

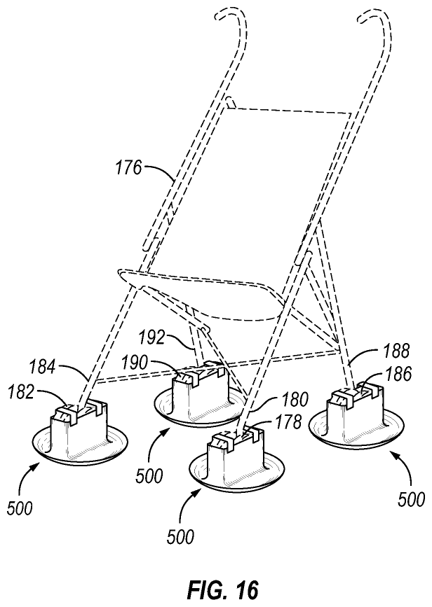

Referring to FIG. 16, example embodiments of an apparatus of the invention are shown being utilized on a device comprising a first stroller 176. First stroller 176 comprises a first double-wheel caster 178 attached to a seventh leg 180. A first apparatus 500 is shown after releasably connecting to first double-wheel caster 178 and seventh leg 180 and releasably securing. First stroller 176 further comprises a second double-wheel caster 182 attached to an eighth leg 184. A second apparatus 500 is shown after releasably connecting to second double-wheel caster 182 and eighth leg 184 and releasably securing. First stroller 176 further comprises a first double-wheel 186 attached to a ninth leg 188. A third apparatus 500 is shown after releasably connecting to first double-wheel 186 and ninth leg 188 and releasably securing. First stroller 176 further comprises a second double-wheel 190 attached to a tenth leg 192. A fourth apparatus 500 is shown after releasably connecting to second double-wheel 190 and tenth leg 192 and releasably securing. First apparatus 500, second apparatus 500, third apparatus 500, and fourth apparatus 500 are shown as example embodiments of a modified apparatus 100 shown in FIG. 1 comprising dimensions of receiving space 22 and receiving space first section 24 for receiving first double-wheel caster 178, second double-wheel caster 182, first double-wheel 186, and second double-wheel 190, respectively. First apparatus 500, second apparatus 500, third apparatus 500, and fourth apparatus 500 shown as example embodiments of a modified apparatus 100 shown in FIG. 1 would generally not comprise receiving space second section 26 of apparatus 100.

Still referring to FIG. 16, one or more frames shown in FIG. 14 and FIG. 15 utilized for a caster wheel may be utilized in lieu of, or in addition to, seventh leg 180, eighth leg 184, ninth leg 188, tenth leg 192, and combinations thereof. One or more frames shown in FIG. 14 and FIG. 15 may comprise dimensions for accommodating the extra wheel of the double-wheel caster or the double-wheel. When one or more frames shown in FIG. 14 and FIG. 15 are utilized in lieu of, or in addition to, seventh leg 180, eighth leg 184, ninth leg 188, tenth leg 192, and combinations thereof, then first apparatus 500, second apparatus 500, third apparatus 500, fourth apparatus 500, and combinations thereof may be example embodiments of a modified apparatus 300 shown in FIG. 7 comprising dimensions of receiving space 22, receiving space first section 24, receiving space second section 26, and receiving space third section 46 for receiving the one or more frames and first double-wheel caster 178, second double-wheel caster 182, first double-wheel 186, and second double-wheel 190. While not shown, first double-wheel caster 178, second double-wheel caster 182, first double-wheel 186, second double-wheel 190, and combinations thereof may further comprise a brake component, for example, a hand brake component, a foot brake component, and combinations thereof where the brake component has been engaged. First double-wheel caster 178, second double-wheel caster 182, first double-wheel 186, second double-wheel 190, and combinations thereof may comprise solid wheels, spoked wheels, and combinations thereof. One or more of the releasably-securing components may contact a wheel, a spoke of a wheel, pass between a spoke of a wheel and an adjacent spoke of the wheel, and combinations thereof.

Referring to FIG. 17, example embodiments of an apparatus of the invention are shown being utilized on a device comprising a second stroller 194. Second stroller 194 comprises a seventh caster wheel 196 attached to a seventh frame 198 comprising a thirteenth frame section 197 and a fourteenth frame section 199. A seventh apparatus 300 is shown after releasably connecting to seventh caster wheel 196 and seventh frame 198 and releasably securing. Seventh apparatus 300 is shown comprising a height of releasably-connecting component 6 and upper perimeter 27 that has been reduced to optional cut line 98 where upper perimeter 27 is generally about half-way down from the top of seventh caster wheel 196. Second stroller 194 further comprises a fifth wheel 202 attached to an eleventh leg 204. A third apparatus 200 is shown after releasably connecting to fifth wheel 202 and eleventh leg 204 and releasably securing. Third apparatus 200 may be provided by rotating apparatus 200 shown in FIG. 4 one-hundred and eighty (180) degrees. Second stroller 194 further comprises a sixth wheel 206 attached to a twelfth leg 208. A third apparatus 100 is shown after releasably connecting to sixth wheel 206 and twelfth leg 208 and releasably securing. Third apparatus 100 may be provided by rotating apparatus 100 shown in FIG. 1 one-hundred and eighty (180) degrees. While not shown, seventh caster wheel 196, fifth wheel 202, sixth wheel 206, and combinations thereof may further comprise a brake component, for example, a hand brake component, a foot brake component, and combinations thereof where the brake component has been engaged. Seventh caster wheel 196, fifth wheel 202, and sixth wheel 206 are shown as spoked wheels. In lieu of spoked wheels, seventh caster wheel 196, fifth wheel 202, sixth wheel 206, and combinations thereof may comprise solid wheels, spoked wheels, and combinations thereof. One or more of the releasably-securing components may contact a wheel, a spoke of a wheel, pass between a spoke of a wheel and an adjacent spoke of the wheel, and combinations thereof.

Still referring to FIG. 17, third apparatus 200 is shown comprising a height of releasably-connecting component 6 and upper perimeter 27 that has been reduced to optional cut line 41 where upper perimeter 27 is generally about half-way down from the top of fifth wheel 202. Third apparatus 100 is shown comprising a height of releasably-connecting component 6 and upper perimeter 27 that has been reduced to optional cut line 41 where upper perimeter 27 is generally about half-way down from the top of sixth wheel 206. Third apparatus 200 is shown comprising, in lieu of first releasably-securing component 28 and second releasably-securing component 34, releasably-securing components comprising an eleventh screw knob fastener 210, a twelfth screw knob fastener 212, a thirteenth screw knob fastener 214, a fourteenth screw knob fastener 216, a fifteenth screw knob fastener 218, and a sixteenth screw knob fastener 220 at a first releasably-securing location, a second releasably-securing location, a third releasably-securing location, a fourth releasably-securing location, a fifth releasably-securing location, and a sixth releasably-securing location, respectively. Screw knob fasteners 210, 212, 214, 216, 218, and 220 comprise knobs, screws, and contacting components as described herein, for example, as described herein for FIGS. 7-9. Screw knob fasteners 210, 212, 214, 216, 218, and 220 each pass through a respective grooved passageway (not shown) as described herein, for example, as described herein for FIG. 9. Third apparatus 100 is shown comprising, in lieu of first releasably-securing component 28 and second releasably-securing component 34, releasably-securing components comprising a seventeenth screw knob fastener 222, an eighteenth screw knob fastener 224, a nineteenth screw knob fastener 226, a twentieth screw knob fastener 228 (not shown, similar to screw knob fastener 218), a twenty-first screw knob fastener 230 (not shown, similar to screw knob fastener 216), and a twenty-second screw knob fastener 232 at a first releasably-securing location, a second releasably-securing location, a third releasably-securing location, a fourth releasably-securing location, a fifth releasably-securing location, and a sixth releasably-securing location, respectively. Screw knob fasteners 222, 224, 226, 228, 230, and 232 comprise knobs, screws, and contacting components as described herein, for example, as described herein for FIGS. 7-9. Screw knob fasteners 222, 224, 226, 228, 230, and 232 each pass through a respective grooved passageway (not shown) as described herein, for example, as described herein for FIG. 9.

Still referring to FIG. 17, eleventh leg 204 and twelfth leg 208 are shown as attached to an inside of fifth wheel 202 and an inside of sixth wheel 206, respectively. Eleventh leg 204 and twelfth leg 208 may be attached to an outside of fifth wheel 202 and an outside of sixth wheel 206, respectively. When eleventh leg 204 and twelfth leg 208 are attached to the outside of fifth wheel 202 and the outside of sixth wheel 206, respectively, third apparatus 200 and third apparatus 100 may be switched so that third apparatus 100 may releasably connect to fifth wheel 202 and eleventh leg 204 and releasably secure and third apparatus 200 may releasably connect to sixth wheel 206 and twelfth leg 208 and releasably secure. Apparatus 300 shown in FIG. 7 may be utilized in lieu of third apparatus 100, third apparatus 200, and combinations thereof. In lieu of second stroller 194, a device, for example, a rollator walker, comprising a configuration of caster wheels, frames, wheels, and legs as described herein for second stroller 194, may be utilized.

Referring to FIG. 18, an example embodiment of an apparatus 600 comprises an adapting component 302 and a releasably-connecting component 304. Adapting component 302 and releasably-connecting component 304 are shown as comprising two separate components prepared by any suitable means as described herein. Adapting component 302 comprises a generally circular shape. Adapting component 302 further comprises a concave adapting component top surface 306. Adapting component 302 further comprises convex adapting component bottom surface 308 providing for an adapting component thickness 310 (not shown, see FIG. 20). Adapting component 302 further comprises a centerline 311. Convex adapting component bottom surface 308 comprises a generally flat section 312. Adapting component 302 further comprises an edge component 314 comprising a generally hemispherical shape totally encompassing a perimeter of adapting component 302. Adapting component 302 further comprises an elevated, generally rectangular, solid component 316 generally located at the middle of adapting component 302. An upper perimeter 318 of solid component 316 is generally located about one-third of the distance between an upper perimeter 320 of adapting component 302 and a lowest point 322 (generally located at the middle of flat section 312) (not shown, see FIG. 20) of convex adapting component bottom surface 308. Solid component 316 comprises a recessed section 324 comprising a bottom surface 326. Recessed section 324 further comprises a first set of eight neodymium magnets 328 each comprising a diameter of 8 millimeters and a thickness of 3 millimeters. Bottom surface 326 of recessed section 324 is generally located about one-half of the distance from upper perimeter 318 of solid component 316 to lowest point 322 (generally located at the middle of flat section 312) (not shown, see FIG. 20) of convex adapting component bottom surface 308. First set of eight magnets 328 are attached to bottom surface 326 by adhesion and may be attached by any suitable means.

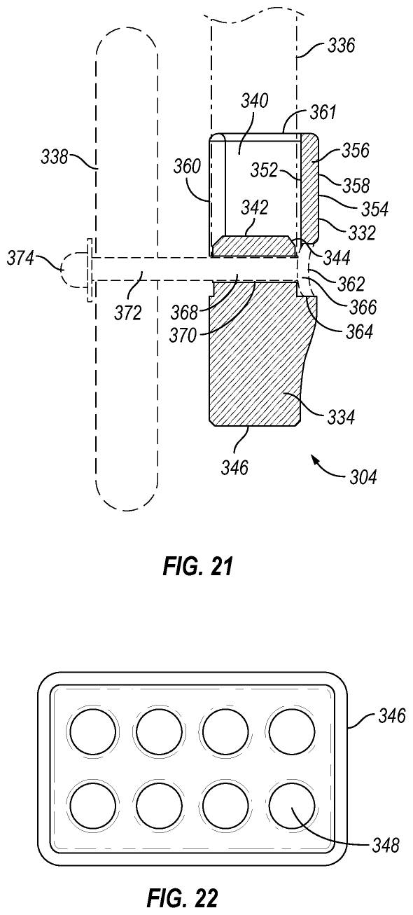

Still referring to FIG. 18, a releasably-connecting component 304 comprises a generally hemi-spherical upper section 332 and a generally rectangular lower section 334. Releasably-connecting component 304 may comprise a leg 336 and a wheel 338 providing for a leg-wheel replacement for a walker or wheeled walker (see, for example, FIG. 21 and FIG. 27). Wheel 338 is shown as a spoked wheel and may comprise a solid wheel, a spoked wheel, and combinations thereof. Upper section 332 comprises dimensions to provide for a receiving space 340 to receive leg 336. Receiving space 340 comprises a generally hemi-spherical space to receive leg 336 (see also, for example, FIG. 21). Receiving space 340 may provide for a generally form-fit of leg 336. Receiving space 340 is shown as vertically straight and may, for example, be vertically angled. A bottom surface 342 of upper section 332 comprises a descending ring shape 344. Lower section 334 comprises a bottom surface 346. Bottom surface 346 comprises a length and a width that are generally slightly smaller than the length and width of recessed section 324 of solid component 316 providing for bottom surface 346 to fit slightly below upper perimeter 318 after releasably connecting. Bottom surface 346 comprises a second set of eight neodymium magnets 348 (not shown, see FIG. 22) each comprising a diameter of 8 millimeters and a thickness of 3 millimeters having an opposite charge to first set of eight magnets 328 of recessed section 324 providing for a releasably connecting and releasably disconnecting of adapting component 302 and releasably-connecting component 304 and further providing for a releasably connecting and releasably disconnecting of adapting component 304 and leg 336 and wheel 338. Second set of magnets 348 are attached to bottom surface 346 by adhesion and may be attached by any suitable means. Dotted arrow line 350 shows a general direction of releasably connecting and releasably disconnecting adapting component 302 and releasably-connecting component 304. After releasably connecting, wheel 338 may be slightly above the convex adapting component top surface 306 and may freely rotate.

Still referring to FIG. 18, releasably-connecting component 304 further comprises a releasably-connecting component inner surface 352 and a releasably-connecting component outer surface 354 providing for a releasably-connecting component thickness 356. Releasably-connecting component inner surface 352 may comprise an adhesive or other adhesion means to provide for a more permanent connecting of releasably-connecting component 304 and leg 336. Releasably-connecting component 304 further comprises a releasably-connecting component wall 358 comprising a generally hemi-spherical shape. Releasably-connecting component wall 358 comprises an edge 360 comprising a generally hemi-spherical shape. Releasably-connecting component wall 358 is shown as comprising one continuous component. Releasably-connecting component 304 further comprises an upper perimeter 361 comprising a generally hemi-spherical shape. Upper perimeter 361 is shown comprising one level. Upper perimeter 361 may comprise more than one level. Upper perimeter 361 may comprise an upper perimeter passageway (not shown) providing for a passageway for a feature of a device for example, a leg, a frame, a foot brake component, and combinations thereof.

Still referring to FIG. 18, apparatus 600 further comprises a releasably-securing component 362 (not shown, see FIG. 21), at a first releasably-securing location comprising a circular, slightly recessed section 364 (not shown, see FIG. 21) of releasably-connecting component 304, comprising a knob 366 (not shown, see FIG. 21) and a shaft 368 (not shown, see FIG. 21). Shaft 368 passes through a passageway 370 and continues through the center of wheel 338 providing for an axle 372 of wheel 338 and comprising an end comprising a nut component 374 (see also FIG. 21). Recessed section 364 and passageway 370 may provide for a passageway form-fit of knob 366 and shaft 368 providing for knob 366 and shaft 368 to be stationary in passageway 370 while wheel 338 may rotate around axle 372. In addition to, or in lieu of, the passageway form-fit, knob 366 and shaft 368 may be connected by adhesion means, lock-nut means, and combinations thereof to releasably-connecting component 304 providing for knob 366 and shaft 368 to be stationary in passageway 370 while wheel 338 may rotate around axle 372.

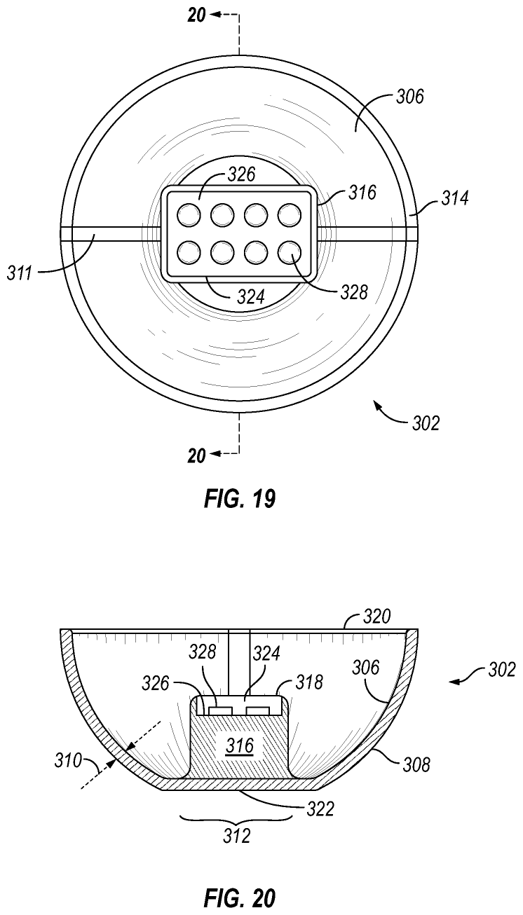

Referring to FIG. 19, concave adapting component top surface 306, centerline 311, edge component 314, generally rectangular, solid component 316, recessed section 324, bottom surface 326, and first set of eight magnets 328 are shown.

Referring to FIG. 20, adapting component 302 shown in FIGS. 18 and 19 is shown in cross-section. FIG. 20 also shows concave adapting component top surface 306, convex adapting component bottom surface 308, adapting component thickness 310, generally flat section 312, and elevated, generally rectangular, solid component 316. FIG. 20 also shows upper perimeter 318 of solid component 316, upper perimeter 320, lowest point 322 (generally located at the middle of flat section 312) of convex adapting component bottom surface 308, recessed section 324, bottom surface 326, and first set of magnets 328.

Referring to FIG. 21, releasably-connecting component 304 of FIG. 18 is shown in cross-section. FIG. 21 also shows generally hemi-spherical upper section 332, generally rectangular lower section 334, leg 336, and wheel 338. FIG. 21 also shows receiving space 340, bottom surface 342, descending ring shape 344, and bottom surface 346. FIG. 21 also shows releasably-connecting component inner surface 352, releasably-connecting component outer surface 354 providing for releasably-connecting component thickness 356. FIG. 21 also shows releasably-connecting component wall 358, edge 360, and upper perimeter 361. FIG. 21 also shows releasably-securing component 362 at a first releasably-securing location comprising circular, slightly recessed section 364, knob 366, and shaft 368. FIG. 21 also shows passageway 370, axle 372 of wheel 338, and nut component 374.

Referring to FIG. 22, bottom surface 346 of releasably-connecting component 304 of FIG. 18 is shown comprising second set of eight magnets 348.

Referring to FIG. 23, an example embodiment of an apparatus 700 comprises an adapting component 402, a releasably-connecting component 404, and a releasably-securing component 406. Adapting component 402, releasably-connecting component 404, and releasably-securing component 406 are shown as comprising three separate components prepared by any suitable means as described herein. Adapting component 402 comprises a generally ellipsoid shape. Adapting component 402 further comprises a concave adapting component top surface 408. Adapting component 402 further comprises a convex adapting component bottom surface 410 providing for an adapting component thickness 411 (not shown, see FIG. 25). Adapting component 402 further comprises a centerline 412. Convex adapting component bottom surface 410 comprises a generally flat section 413. Adapting component 402 further comprises an edge component 414 comprising a generally hemispherical shape totally encompassing a perimeter of adapting component 402. Adapting component 402 further comprises an elevated, generally circular, solid component 416 generally located at the middle of adapting component 402. An upper perimeter 418 (not shown, see FIG. 25) of solid component 416 is generally located one-third of the distance between an upper perimeter 420 of adapting component 402 and a lowest point 422 (generally at the middle of flat section 413) (not shown, see FIG. 25) of convex adapting component bottom surface 410. Solid component 416 comprises dimensions to provide for a receiving space 423. Receiving space 423 comprises a generally circular shape to receive a leg (see, for example, FIG. 27). Receiving space 423 provides for a generally form-fit of a leg. Solid component 416 further comprises a first upper section 424 comprising a first set of five neodymium magnets 426 each comprising a diameter of 8 millimeters and a thickness of 3 millimeters and a first recessed section 428 comprising a first set of seven neodymium magnets 430 each comprising a diameter of 8 millimeters and a thickness of 3 millimeters. First upper section 424 comprises a bottom surface 432. Bottom surface 432 of first upper section 424 is generally located about one-third of the distance from upper perimeter 420 of adapting component 402 to lowest point 422 (generally located at the middle of flat section 413) (not shown, see FIG. 25) of convex adapting component bottom surface 410. First recessed section 428 comprises a bottom surface 434. Bottom surface 434 of first recessed section 428 is generally located about one-half of the distance from upper perimeter 418 of solid component 416 to lowest point 422 (generally located at the middle of flat section 413) (not shown, see FIG. of convex adapting component bottom surface 410. First set of five magnets 426 and first set of seven magnets 430 are attached to bottom surface 432 and bottom surface 434, respectively, by adhesion and may be attached by any suitable means.

Still referring to FIG. 23, releasably-connecting component 404 comprises a generally hemi-spherical upper section 436 and a generally circular lower section 438. Upper section 436 and lower section 438 are shown as one continuous component and may comprise separate components connected by any suitable means. Releasably-connecting component 404 may comprise a leg 440 providing for a leg replacement for a walker or wheeled walker (see, for example, FIG. 27). Upper section 436 comprises dimensions to provide for a receiving space 442 to receive leg 440. Receiving space 442 comprises a generally hemi-spherical shape to receive leg 440 (see also, for example, FIG. 27). Receiving space 442 provides for a generally form-fit of leg 440. Receiving space 442 is shown as vertically straight and may, for example, be vertically angled. Lower section 438 comprises a first recessed section 444 comprising a second set of five neodymium magnets 446 (not shown, see FIG. 26) each comprising a diameter of 8 millimeters and a thickness of 3 millimeters. Lower section 438 further comprises a second lower section 448 comprising a second set of seven neodymium magnets 450 (not shown, see FIG. 26) each comprising a diameter of 8 millimeters and a thickness of 3 millimeters. Lower section 438 further comprises a first bottom surface 452 (not shown, see FIG. 26) and a second bottom surface 453 (not shown, see FIG. 26). Second set of five magnets 446 and second set of seven magnets 450 are attached to first bottom surface 452 and second bottom surface 453, respectively, by adhesion and may be attached by any suitable means. Second set of five magnets 446 and second set of seven magnets 450 of releasably-connecting component 404 comprise an opposite charge to first set of five magnets 426 and first set of seven magnets 430 of adapting component 402 providing for a releasably connecting and releasably disconnecting of adapting component 402 and releasably-connecting component 404 and further providing for a releasably connecting and releasably disconnecting of adapting component 402 and leg 440. Dotted arrow line 454 shows a general direction of releasably connecting and releasably disconnecting adapting component 402 and releasably-connecting component 404. Upper section 424 and recessed section 428 of adapting component 402 provide for a lip-lock function with recessed section 444 and lower section 448 of releasably-connecting component 404 after releasably connecting adapting component 402 and releasably-connecting component 404. After releasably connecting, the terminal end of leg 440 may be slightly above the convex adapting component top surface 408.

Still referring to FIG. 23, upper section 436 of releasably-connecting component 404 comprises an upper section inner surface 456 and an upper section outer surface 458 providing for an upper section thickness 460. Upper section 436 further comprises an upper section wall 462 comprising a generally hemi-spherical shape. Upper section wall 462 comprises a first edge 464 comprising a generally hemi-spherical shape and a second edge 466 comprising a generally flat shape. Upper section wall 462 is shown as comprising one continuous component. Upper section inner surface 456 may comprise an adhesive or other adhesion means to provide for a more permanent connecting of releasably-connecting component 404 and leg 440. Lower section 438 of releasably-connecting component 404 comprises a lower section inner surface 468 and a lower section outer surface 470 providing for a lower section thickness 472. Lower section 438 further comprises a lower section wall 474 comprising a generally circular shape. Lower section wall 474 comprises an upper edge 476 comprising a generally hemi-spherical shape and a lower edge 477 comprising a generally flat shape. Lower section wall 474 is shown as comprising one continuous component. Lower section 438 comprises dimensions to provide for a receiving space 478 to receive leg 440. Receiving space 478 comprises a generally circular shape to receive leg 440 (see also, for example, FIG. 27). Receiving space 478 may provide for a generally form-fit of leg 440. Receiving space 478 is shown as vertically straight and may, for example, be vertically angled. Lower section inner surface 468 may comprise an adhesive or other adhesion means to provide for more permanent connecting of releasably-connecting component 404 and leg 440.

Still referring to FIG. 23, upper section 436 further comprises an upper section perimeter 480. Upper section perimeter 480 is shown comprising one level. Upper section perimeter 480 may comprise more than one level. Upper section perimeter 480 may comprise an upper section perimeter passageway (not shown) providing for a passageway for a feature of a device for example, a leg, a frame, a foot brake component, and combinations thereof. Lower section 438 further comprises a lower section perimeter 482 (not shown, see FIG. 26) comprising two levels. Lower section perimeter 482 may comprise one level or more than one level. Lower section perimeter 482 may comprise a lower section perimeter passageway (not shown) providing for a passageway for a feature of a device for example, a leg, a frame, a foot brake component, and combinations thereof. Upper section wall 462 is shown as less than slightly flush with lower section wall 474 and may be flush. Upper section 436 further comprises a first set of six generally circular passageways 484 that align with a second set of six generally circular passageways of releasably-securing component 406 as described herein.

Still referring to FIG. 23, releasably-securing component 406 comprises a releasably-securing component inner surface 486 and a releasably-securing component outer surface 488 providing for a releasably-securing component thickness 490. Releasably-securing component 406 further comprises a releasably-securing component wall 492 comprising a generally hemi-spherical shape. Releasably-securing component wall 492 comprises a first edge 494 comprising a generally hemi-spherical shape and a second edge 495 comprising a generally flat shape. Releasably-securing component wall 492 is shown as comprising one continuous component. Releasably-securing component 406 comprises dimensions to provide for a receiving space 496 to receive leg 440. Receiving space 496 comprises a generally hemi-spherical shape to receive leg 440 (see also, for example, FIG. 27). Receiving space 496 may provide for a generally form-fit of leg 440. Receiving space 496 is shown as vertically straight and may, for example, be vertically angled. Releasably-securing component inner surface 486 may comprise an adhesive or other adhesion means to provide for more permanent securing of releasably-securing component 404 and leg 440. Releasably-securing component 404 further comprises an upper perimeter 498. Upper perimeter 498 is shown comprising one level. Upper perimeter 498 may comprise more than one level. Upper perimeter 498 may comprise an upper perimeter passageway (not shown) providing for a passageway for a feature of a device for example, a leg, a frame, a foot brake component, and combinations thereof. Releasably-securing component 406 further comprises a second set of six generally circular passageways 500 that align with first set of six generally circular passageways 484 of upper section 436 of releasably-connecting component 404. Dotted arrow line 502 shows a general direction of releasably securing and releasably unsecuring releasably-connecting component 404 and releasably-securing component 406. A set of six screws (not shown), for example, six self-tapping screws, may each be passed through the first set of passageways 484 and second set passageways 500 providing for a releasably securing of releasably-connecting component 404 and releasably-securing component 406. The screws may be tightened down utilizing screw nuts. Releasably-securing component 406 further comprises a generally circular passageway 504 and a generally semi-circular passageway 506 that may provide for a passing of various height adjustment buttons or screws of leg 440.

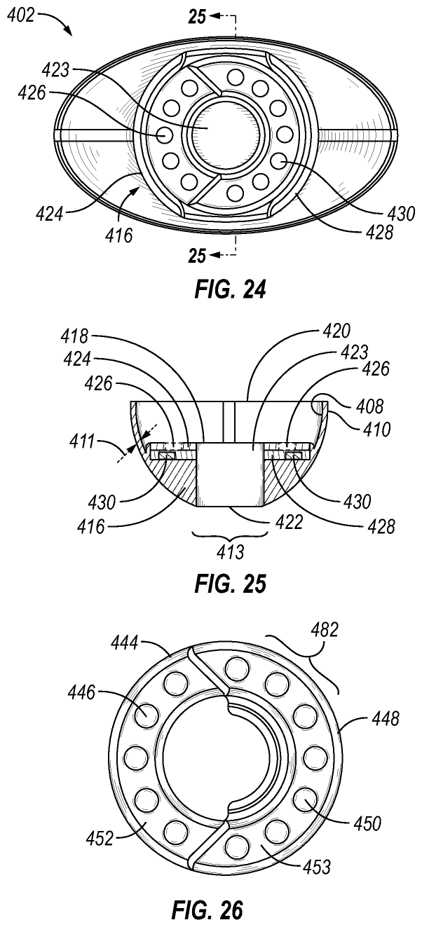

Referring to FIG. 24, elevated, generally circular, solid component 416, generally circular receiving space 423, first upper section 424, first set of five magnets 426, first recessed section 428, and first set of seven magnets 430 of adapting component 402 are shown.

Referring to FIG. 25, adapting component 402 shown in FIGS. 23 and 24 is shown in cross-section. FIG. 25 also shows concave adapting component top surface 408, convex adapting component bottom surface 410, adapting component thickness 411, and generally flat section 413. FIG. 25 also shows elevated, generally circular, solid component 416 generally located at the middle of adapting component 402. FIG. 25 also shows upper perimeter 418 of solid component 416, upper perimeter 420 of adapting component 402, and lowest point 422 (generally located at the middle of flat section 413) of convex adapting component bottom surface 410. FIG. 25 also shows generally circular receiving space 423. FIG. 25 also shows first upper section 424 comprising first set of five magnets 426 and first recessed section 428 comprising first set of seven magnets 430.

Referring to FIG. 26, first recessed section 444, second set of five magnets 446, first lower section 448, second set of seven magnets 450, first bottom surface 452, second bottom surface 453, and perimeter 482 of releasably-connecting component 404 are shown.

Referring to FIG. 27, example embodiments of an apparatus of the invention are shown being utilized on a device comprising wheeled walker 127. Wheeled walker 127 comprises first wheel 128 attached to first leg 130. A first apparatus 600 is shown after releasably connecting to first wheel 128 and first leg 130. Wheeled walker 127 further comprises second wheel 132 attached to second leg 134. A second apparatus 600 is shown after releasably connecting to second wheel 132 and second leg 134. Wheeled walker 127 further comprises third leg 136. A first apparatus 700 is shown after releasably connecting to third leg 136. Wheeled walker 127 further comprises fourth leg 138. A second apparatus 700 is shown after releasably connecting to fourth leg 138. First wheel 128, second wheel 132, and combinations thereof may comprise solid wheels, spoked wheels, and combinations thereof. One or more of the releasably-securing components may contact a leg, a wheel, a spoke of a wheel, pass between a spoke of a wheel and an adjacent spoke of the wheel, and combinations thereof. First leg 130 and second leg 134 are shown as attached to an inside of first wheel 128 and an inside of second wheel 132, respectively. First leg 130 and second leg 134 may be attached to an outside of first wheel 128 and an outside of second wheel 132, respectively. When first leg 130 and second leg 134 are attached to the outside of first wheel 128 and the outside of second wheel 132, respectively, releaseably-connecting component 304 of first apparatus 600 and releasably-connecting component 304 of second apparatus 600 may be located outside of first wheel 128 and outside of second wheel 132, respectively.

The foregoing description is intended as a means of illustration and should not be construed as limiting the scope of the invention in any way. Those skilled in the art will recognize many variations that may be made without departing from the spirit of the disclosed invention.

What is claimed is:

1. An apparatus comprising an adapting component and a releasably-connecting component.

2. An apparatus according to claim 1 wherein the adapting component comprises a discal component.

3. An apparatus according to claim 1 wherein the adapting component comprises a discal component selected from the group consisting of a circular disc, a spherical disc, a spheroid disc, an oval disc, an ovoid disc, an ovaloid disc, an elliptical disc, an ellipsoid disc, and combinations thereof.

4. An apparatus according to claim 1 wherein the adapting component comprises a concave discal component.

5. An apparatus according to claim 1 wherein the adapting component comprises a concave discal component selected from the group consisting of a concave circular disc, a concave spherical disc, a concave spheroid disc, a concave oval disc, a concave ovoid disc, a concave ovaloid disc, a concave elliptical disc, a concave ellipsoid disc, and combinations thereof.

6. An apparatus according to claim 1 wherein the adapting component comprises a concave circular disc.

7. An apparatus according to claim 1 wherein the adapting component comprises an edge component.

8. An apparatus according to claim 1 wherein the releasably-connecting component comprises a receiving space.

9. An apparatus according to claim 1 further comprising a releasably-securing component.

10. An apparatus according to claim 1 further comprising a releasably-securing component wherein the releasably-securing component is selected from the group consisting of a fastener, a latch, a clamp, a wedge, a strap, a cable, a wire, a rope, and combinations thereof.

11. An apparatus according to claim 1 further comprising an electronic component.

12. An apparatus according to claim 1 further comprising an electronic component selected from the group consisting of a photo component, a video component, an internet component, and combinations thereof.

13. An apparatus according to claim 1 further comprising an electronic component wherein the electronic component comprises a wireless connection to the internet.

14. A process comprising releasably connecting an apparatus and a device wherein the apparatus comprises an adapting component and a releasably-connecting component.

15. A process according to claim 14 wherein the device comprises a wheel, a leg, a frame, and combinations thereof and wherein the process further comprises releasably connecting the wheel, the leg, the frame, and combinations thereof.

16. A process according to claim 14 further comprising releasably disconnecting the apparatus and the device.

17. A process according to claim 14 further comprising releasably securing the apparatus and the device, releasably unsecuring the apparatus and the device, and combinations thereof.

18. A process according to claim 14 further comprising adapting the device to a land surface.

19. A process according to claim 14 wherein the device is selected from the group consisting of a walker, a wheeled walker, a rollator walker, a gait trainer, a stroller, and combinations thereof.

20. A process according to claim 14 wherein the land surface is selected from the group consisting of dirt, mud, grass, sand, snow, and combinations thereof.
